(19) United States
(12) Patent Application Publication
(10) Pub. No.: US 2009/0175530 A1
(43) Pub. Date: Jul. 9, 2009

(54) Methods and apparatuses for detecting pattern errors

(76) Inventors: Fredrik Sjostrom, Taby (SE); Peter Ekberg, Lidingo (SE)

Correspondence Address: HARNESS, DICKEY & PIERCE, P.L.C., P.O. BOX 8910, RESTON, VA, 20195, US

(21) Appl. No.: 12/292,152

(22) Filed: Nov. 12, 2008

Related U.S. Application Data
(60) Provisional application No. 60/987,186, filed on Nov. 12, 2007.

(51) Int. Cl. G06K 9/00; H04N 7/18

(52) U.S. Cl. 382/152; 348/92; 348/E07.085

(57) ABSTRACT

Methods and apparatuses for quality control and detecting errors related to the manufacturing and production of more accurate patterns and resultant devices are provided. The patterns or devices may include patterns used in display applications such as TFT-LCD, OLED, SED, PDP, FED, LTPS-LCD and similar display technologies using at least partially cyclical patterns.

### PRIORITY STATEMENT

This nonprovisional patent application claims priority under 35 U.S.C. § 119(e) to provisional U.S. patent application No. 60/987,186, filed on Nov. 12, 2007 in the United States Patent and Trademark Office, the entire contents of which is incorporated herein by reference.

### BACKGROUND

Conventionally, methods for die-to-die inspection of cyclical patterns include comparing a reference image with a recorded image of a portion of a pattern (e.g., a pixel or other repeating pattern unit) to be inspected. An example of such a method is described in U.S. Pat. No. 5,640,200, the entire contents of which are incorporated herein by reference. In this conventional method, a “golden template” is created based on a plurality of test images and later compared to test images.

A reference image may be created in numerous ways such as averaging many images from different portions of an entire pattern, calculating a reference image from data, etc. But, the accuracy in the comparison between a reference image and a recorded portion of a pattern is limited due to, for example, errors related to the creation of the reference image.

Other conventional methods for die-to-die inspection to detect errors between repeated pattern units or groups of repeated pattern units in a pattern include comparing different pixels or other repeating pattern units from different portions of the full pattern with one another.

Yet another conventional method includes comparing multiple images of the same portion of a pattern, wherein each image is recorded under different conditions with the same imaging acquisition unit. An example of this conventional method is described in U.S. Pat. No. 6,298,149, the entire contents of which is incorporated herein by reference. In this conventional method, a first image of a pattern and a second image of the same pattern are generated, and the second image is subtracted from the first image to identify errors in an image.

These conventional methods are, however, subject to certain drawbacks and numerous error sources. For example, if two image acquisition units (e.g., Charge Couple Device (CCD) cameras, Complementary Metal Oxide Silicon (CMOS) cameras, scanning line systems, etc.) are used in parallel and images from these units are compared, artefacts resulting from the individual camera calibrations, individual optics, and/or individual electronics reduce the accuracy at which the real errors (e.g., CD errors) can be determined. The difference between the images recorded by multiple cameras is not only dependent on the difference in the actual pattern, but also the fact that two different cameras are used. Also, the fact that the multiple recorded images are taken from different portions of a workpiece may limit the accuracy with which the difference can be determined. For example, if the reflectance or transmittance is different for two different sites, the images may be perceived as different when compared even though the two sites, when inspected, are essentially the same.

Even when one imaging acquisition unit is used to record multiple images at different sites or at different times on a workpiece, accuracy of the error detection is reduced. For example, if the transmittance or reflectance of a workpiece is different at different sites of the workpiece or the lighting conditions change over time, the quality of the comparison between two images suffers.

When two images of essentially the same pattern part are recorded under different conditions (e.g., lighting, polarization, timestamps, etc.), the change in condition and the time between image recordings deteriorates the accuracy of the error detection.

In the case where a reference image is used in the comparison, the quality of the reference image is important. If such an image is created by averaging images from numerous sites within a pattern, the difference in, for example, the amount of transmitted or reflected light, deteriorates the reference image, which reduces the accuracy with which the difference between repeated pattern units can be determined.

One type of error that is cyclical in nature is called a mura defect. A mura defect is defined as areas of illumination, which are different or anomalous from the surroundings. Numerous conventional methods for detecting mura defects in finished display modules or after cell assembly are known. For example, U.S. Pat. No. 5,917,935, the entire contents of which is incorporated herein by reference, describes a method for detecting mura defects in flat panel displays. In this conventional method, a high quality image of the finished module is acquired and the difference in illumination is analyzed to detect and classify different types of mura defects. However, this conventional method detects mura late in the manufacturing process. Detecting errors late in a manufacturing process, rather than early, inevitably leads to an increase in cost due to the increased value of the product in each manufacturing step.

Inspection of, for example, photomasks to detect mura defects or errors is normally performed by illuminating the photomask with an external light source, from the back side or the front side, commonly at an oblique angel. The reflected or transmitted scattered light is then detected, directly or indirectly via a light acquisition system, bye a human eye to detect unevenness or discrepancies in the ideally uniform light.

Because manual inspection is organoleptic, its use leads to uncertainty in mura quality control because this conventional method is highly subjective and the appearance and severity of mura defects are perceived differently by different individuals. Moreover, properties such as lamp intensity, viewing angle, surroundings, pattern design, etc., limit the potential to achieve an objective result.

Japanese patent JP 10-300447 A (1998), the entire contents of which is incorporated herein by reference, discloses an automated variant of the method mentioned immediately above. In this conventional method, mura defects are detected using a Time Delay and Integration (TDI) sensor that detects scattered light from pattern edges, instead of a human eye. This conventional method is also limited, however, when it comes to classifying different error sources of the detected defects as well as the size of the errors causing the defects. Further, detecting parts of a cyclical pattern close to the edge of said cyclical pattern using this conventional method may be rather difficult or impossible.

However, even if the apparatus described in JP 10-300447 A (1998) is capable of detecting mura defects, the apparatus is unable to qualitatively evaluate the mura defect, and thus, is unable to differentiate a mura defect that requires further inspection from that which does not. This conventional apparatus is also unable to quantitatively evaluate the mura defect based on its intensity. U.S. Patent Application Publication No. 2005/0271262 discloses conventional calibration methods addressing this limitation.

In U.S. Patent Application Publication No. 2005/0271262, predetermined patterns (calibration plates) with known properties and types of mura defects are inspected to establish the sensitivity of the set-up (the detection sensitivity of the mura defect inspecting apparatus). The detection sensitivity is determined by the light receiver and an analyzing device. Whether the sensitivity is adequate is determined by detecting pseudo mura defects in mura defect inspection masks by the mura defect inspecting apparatus. The previously mentioned conventional methods or variations thereof are sub-optimal ways of quantitatively detect mura because they rely on organoleptic judgment or the use of calibration plates.

Further, error sources like global differences (e.g., differences in reflections and transmittance of the workpiece to be inspected), edge of pattern detection problems, angle errors of the lighting set-up, lighting stability, high pattern dependency of detection accuracy, etc., deteriorate the quality of mura detection.

Because mura is conventionally detected by eye or by a light intensity measuring device, for example a CCD camera, mura defects may be very hard to detect in “bright masks,” for example, masks with a relatively high ratio of reflected/transmitted light. The same error in position or error in critical dimension (CD) on two masks will have different visibility hence be judged differently.

In one example, consider a pattern that includes opaque lines measuring about 9 μm and spaces between the opaque lines measuring about 1 μm (e.g., pitch 10 μm), as shown in FIG. 1, for which the transmission is about 10%. By introducing an error of about 50 nm (e.g., one space becomes about 1.05 μm), the transmission for that part of the pattern becomes about 10.5%. The ratio between the transmission in that part of the pattern and the rest of the pattern (e.g., the contrast) becomes about 5%. This error will be clearly visible.

Then consider another pattern that includes of opaque lines measuring about 1 μm and spaces measuring about 9 μm between the opaque lines (e.g., pitch 10 μm), for which the transmission becomes about 90%. By introducing the same error of about 50 nm (e.g., one space becomes about 9.05 μm), the transmission for that part of the pattern becomes about 90.5%. In this case the contrast only becomes about 0.5%. In this relatively elementary example the visibility of the same error decreases about 10 times based only on the polarity of a pattern. If the visibly is not linear hence the visibility of certain errors will even be more affected.

Another way of illustrating the difference in visibility between different patterns is described in FIG. 2 where two different patterns A and B are shown. The same error is introduced in both images, but identifying the variation in the pattern A, wherein the error results in a higher change in transmission, is more readily visible and detectable than the variation in pattern B.

Accordingly, the visibility caused by the presence of an error in a cyclical pattern with a constant or substantially constant pitch depends on the ratio between, in this example, clear field and dark fields or pattern polarity. To put it in another way, the base transmission, reflection or other visibility affecting properties highly affect the accuracy of which mura defects may be detected. This normally leads to patterns being judged to be acceptable even if errors that will damage the final device in the case detection of templates, photomasks, substrates wafers, etc., are present. The mura defect detection ability is dependent on the pattern which is being inspected.

Another problem when using a conventional CCD or similar cyclical sensor device for inspecting a cyclical pattern is that the beating between the cyclical pattern being inspected and the systematic pitches on the CCD (distance between the individual sensors) generates moiré in the recorded image. This complicates the analyzing step when detecting mura defects within recorded images.

A conventional CCD camera may have a construction similar to a flat panel display. Each pixel in the camera responds to light by outputting an electrical signal (with a voltage), which is proportional to the amount of light incident on the camera pixel. The camera pixel includes a border that does not respond to light. Each of the pixels are spaced equally from each other to form a two dimensional periodic pattern. The pattern of pixels forms discrete sampling points of light intensity that define the image impinging on the CCD camera.

Discrete sampling of the image by the camera pixels creates an interference pattern commonly known as moiré interference. The interference pattern is a periodic modulation of an image voltage signal created by the CCD camera. The period of modulation is a function of the period of the pattern of the CCD pixels and the flat panel pixels. The periodic modulation of the image often impedes the ability of an inspection system to detect and characterize real defects present on the flat panel display. The real defects also modulate the signal, but tend not be periodic in nature.

Some conventional methods to reduce moiré artefacts have been proposed. For example, U.S. Pat. No. 7,095,883, the entire contents of which is incorporated herein by reference, discloses a method in which a number of images including moiré patterns are recorded. The images are combined to form a reference image including a moiré pattern, and the reference image is combined with a sample image to inhibit the moiré pattern to form a test image.

A conventional method for reducing the effects of moiré in recorded images is described in, for example, U.S. Pat. No. 7,095,883, the entire contents of which is incorporated herein by reference. In this conventional method, suppression of moiré artefacts is performed by creating a reference moiré image (by combining numerous recorded pattern images) and then deducting this reference image from sample images taken during an inspection phase.

U.S. Pat. No. 5,764,209, the entire contents of which is incorporated herein by reference, discloses conventional methods to overcome impacts of mismatch between a cyclical image sensor and a cyclical pattern. These conventional methods include using a limited number of sensor elements in each image and using many images, by averaging many recorded images in different positions as well as filtering the recorded images to remove certain beat frequencies.

Other conventional methods for dealing with the destructive presence of moiré are disclosed in U.S. Pat. No. 5,764,209, the entire contents of which are incorporated herein by reference. In this example, intensities from many images recorded at different shifted positions are canceled out. In this example, the recorded images are camera shifted rather than pattern shifted.

### SUMMARY

Example embodiments relate to methods and apparatuses for quality control and detecting errors related to the manufacturing and production of more accurate patterns and resultant devices. The patterns or devices may include patterns used in display applications such as thin-film-transistor liquid crystal display (TFT-LCD), organic light emitting diode (OLED), Surface-conduction Electron-emitter Display (SED), Plasma Display Panel (PDP), Field Emission Display (FED), Low-Temperature Poly-Silicon-LCD (LTPS-LCD) and similar display technologies using at least partially cyclical patterns. The patterns may further include patterns of sensor devices such as CCD sensors, CMOS sensors and other sensor or image pick-up (acquisition) technologies that are cyclical (or periodic) in nature.

Example embodiments also relate to quality control of other devices or materials used for production of devices that are cyclical in nature such as memories (e.g., static random access memory (SRAM), dynamic random access memory (DRAM), flash memory, ferroelectric memory, ferromagnetic memory, etc.), optical devices that are characterized by cyclical patterns (e.g., gratings, scales, Diffractive Optical Elements (DOEs), kinoforms, holograms, etc.) as well as other cyclical structures such as 3D structures, imprinting stamps, offset plates, reliefs, etc.

The carrier of these accurate patterns, hereafter referred to as workpiece, may be (but is not limited to) semiconductor wafers, plastic materials (e.g., Poly-Ethylene Terephthlalete (PET), Poly-Ethylene Naphthalate (PEN), etc.), chrome coated quartz masks, flexible materials, metals, etc. Specific examples may be glass substrates used for display manufacturing, photomasks used for lithography, semiconductor wafers, elastomer based templates, etc.

Example embodiments further relate to detecting defects in at least partially cyclical patterns. Such defects or errors may be defined as (but are not limited to) differences in critical dimension (CD) or linewidth from an intended value for a specific feature or group of features, a difference in placement from an intended position for a specific feature or group of features, a difference in pitch between features or groups of features or a difference in shape between specific features or groups of features. The intended CD value or intended position of a feature may be derived from the pattern design or defined by the pattern itself.

Example embodiments further relate to detecting defects in a cyclical pattern or structure in a direction or plane having an oblique angle to the surface plane of the workpiece to be inspected and/or having an oblique angle to the angle of incidence of the writing beams, imprinting stamp or press roller used to create the cyclical pattern or structure, for example, detecting defects in a slanted plane, “inspection surface,” having a cyclical 3D structure created by embossing techniques.

Example embodiments further relate to methods for die-to-die inspection. Die-to-die inspection is the comparison between equal or at least similar features in an at least partially cyclical pattern. These features may include actual recorded pattern units, measured pattern units or other image representations.

Example embodiments further relate to (but are not limited to) errors or defects commonly referred to as mura defects. Mura defects are separate in character from more isolated pattern errors such as for instance opens, shorts, pinholes, etc., by being distributed over a larger area of the workpiece. In other words, mura defects are generally not point defects. Detecting mura defects is known to be problematic using conventional inspection methods because conventional inspection methods normally focus on a relatively small part of a cyclical pattern. As a result, a mura defect may look like a pattern regularly arranged so far as a microscopic pattern inspection is applied.

Once an area from a larger portion of a pattern is observed, a mura defect may be identified as the part of a pattern that is different from the main part of the pattern.

When a mura defect exists in an a sensor device or a display device, sensitivity fluctuation or display fluctuation may be generated, which may lower device performance. Further, when a mura defect is generated in a pattern of a photomask or similar manufacturing template, which is used for fabricating an sensor device, a display device or any other device that is cyclical in nature, the mura defect may be transferred to the pattern of the image device, which also lowers performance of the image device.

Example embodiments also relate to problems commonly known as moiré artefacts. Moiré artefacts are problems related to image deterioration caused the recording of cyclical patterns by image recording devices that are cyclical (or periodic) in nature.

At least one example embodiment provides a method in which the difference between repeated features in cyclical patterns may be determined with relatively high accuracy. At least one example embodiment also provides a method in which the recorded images of a pattern to be inspected is, in a sense, compared to itself. As a result, error sources related to stored reference images, variations in external conditions due to time between image recording or multiple site images are eliminated. This intra-image comparison may achieve relatively high accuracy in detecting deviations in, for example, CD, shape and/or position between individual repeated pattern units by eliminating or at least reducing the error sources normally plaguing conventional techniques.

At least some example embodiments further reduce differences in detection accuracy depending on the pattern design. For example, according to at least some example embodiments, the duty cycle or base contrast of the pattern does not limit the accuracy.

Example embodiments do not require a display to be functional in order to identify mura defects hence the error detection may be performed upstream in a normal device production flow.

Example embodiments also relate to mura detection. Conventional and prior art methods of mura detection have a number of shortcomings addressed by example embodiments. For example, methods discussed herein are not dependent on oblique incident light, rather the opposite, image acquisition perpendicular or substantially perpendicular relative to the inspection surface. This makes it, inter alia, suitable for accurate inspection of the entire pattern without reducing the detection accuracy close to the pattern edge.

Example embodiments also provide various methods for detecting mura defects in an objective and/or quantitatively manner, without the use of given or pre-determined calibration plates to classify different types of mura defects.

Example embodiments provide methods for detecting mura and/or point defects, wherein the effects of differences in inspected pattern designs are reduced. The method enables error detection to be performed in an environment in which the polarity or duty-cycle of a periodical pattern is of little or no importance.

Example embodiments provide methods to reduce the potential presence of moiré, in cyclical sensor recordings, of at least partially cyclical patterns.

Example embodiments provide methods and apparatus for detecting deviations and/or defects on a workpiece including an at least partially cyclical structure, and/or deviations and/or defects on a workpiece at least partly covered with a cyclical pattern.

Example embodiments provide a faster, more efficient and straight forward method for detecting relatively small errors in cyclical patterns with increased accuracy by basing the error/defect detection primarily on data from singular images compared with themselves.

Another example embodiment provides a method for detecting relatively small errors in cyclical patterns independently of the pattern design relative to duty cycle or polarity.

Another example embodiment provides a method for die-to-die inspection without the use of a reference image, multiple image acquisition units, or recording the same image at more than one instance in time.

Another example embodiment provides a method for die-to-die inspection without comparing different sites in a pattern recorded by different image acquisition systems.

Another example embodiment provides a more effective method to detect relatively small errors in cyclical patterns without the use of complex filtering or edge determination functions.

Another example embodiment provides a method of determining the magnitude of a defect.

Another example embodiment provides a method in which mura and/or moiré defects may be detected and classified based on statistical calculations.

Another example embodiment merges information from several images that may be at least partially overlapping to detect mura and/or moiré defects.

Another example embodiment uses several images in combination with classification of various mura and/or moiré errors and/or statistics from previous mura and/or moiré generation to detect mura and/or moiré defects.

Another example embodiment provides methods for increasing the quality of recorded images while suppressing and/or controlling moiré effects.

### BRIEF DESCRIPTION OF THE DRAWINGS

The drawings described herein are for illustrative purposes only of selected, example embodiments and not all possible implementations, and are not intended to limit the scope of the present disclosure.

FIG. 1 illustrates a pattern including opaque lines measuring about 9 μm and spaces between the opaque lines measuring about 1 μm (e.g., pitch 10 μm).

FIG. 2 is an example for illustrating the difference in visibility between different patterns.

FIG. 3 illustrates, in a conceptual form, an image acquisition device for implementing methods according to example embodiments.

FIG. 4 illustrates a rotated portion of a cyclical pattern placed on a CCD grid.

FIG. 5 shows a limited number of point sources emitting light defining a rectangular figure.

FIG. 6 illustrates an analog model of a demodulator implementing Equation (2).

FIG. 7 is a flow chart illustrating a method for error detection according to an example embodiment.

FIG. 8 illustrates an example acquired image and a difference image.

FIG. 9 illustrates another example acquired image and a difference image.

FIG. 10 illustrates a portion of a virtual grid for illustrating an example 4 point interpolation.

FIGS. 11A-11D show a comparison of what happens with the interpolation error when sampling a signal with different derivatives of the edge and using a rough sampling grid.

FIG. 12 shows a portion of a pattern for explaining rotation errors.

FIG. 13 is an example showing results after performing the shift operation such that only useful information remains in the gray shaded areas of the difference image.

FIG. 14 shows a cross section graph for explaining a method of estimating pitches according to example embodiments.

FIG. 15 illustrates another method for error detection according to an example embodiment.

FIG. 16 is a cross section obtained after shifting the image represented by the cross section shown in FIG. 11B by 20.5 μm in the Y direction.

FIG. 17 shows the Flat Panel Display Measurement Standard (FPDM) for classifying errors in finished FPD modules as defined Video Electronics Standards Association (VESA).

FIG. 18 is a geometrical presentation of what happens during a first and second shift of the method for detecting errors according to an example embodiment.

FIG. 19 shows an example of some overlapping images captured in the X-direction, for example, using the image acquisition unit shown in FIG. 3.

FIG. 20 is an example illustrating a super sampling method in which each pixel in the camera samples an edge at different physical points of the transfer function when following the edge.

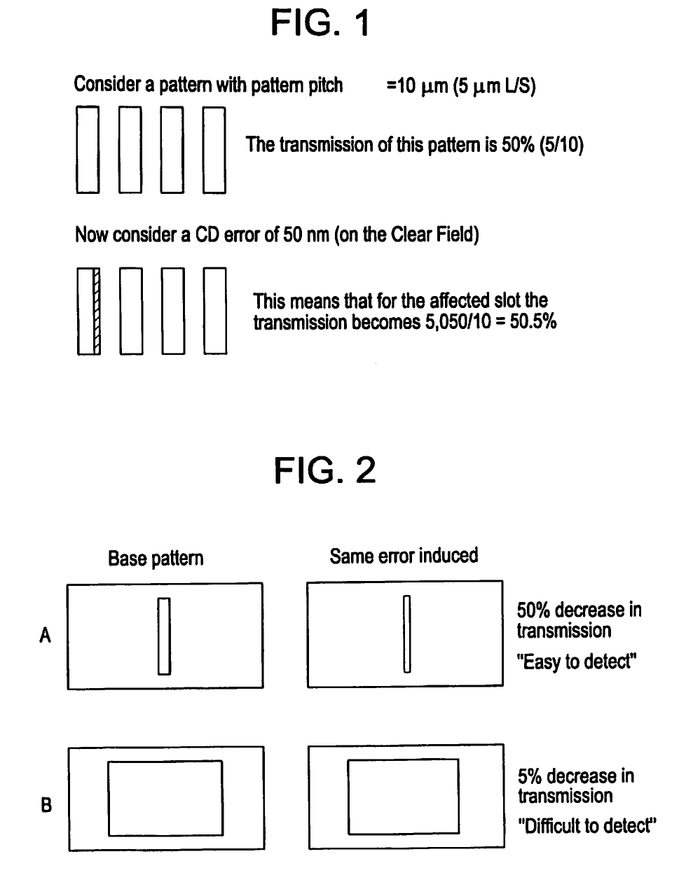

Corresponding reference numerals indicate corresponding parts throughout the several views of the drawings.

### DETAILED DESCRIPTION OF EXAMPLE EMBODIMENTS

Various example embodiments of the present invention will now be described more fully with reference to the accompanying drawings in which some example embodiments of the invention are shown. In the drawings, the thicknesses of layers and regions are exaggerated for clarity.

Detailed illustrative embodiments of the present invention are disclosed herein. However, specific structural and functional details disclosed herein are merely representative for purposes of describing example embodiments of the present invention. This invention may, however, may be embodied in many alternate forms and should not be construed as limited to only the embodiments set forth herein.

Accordingly, while example embodiments of the invention are capable of various modifications and alternative forms, embodiments thereof are shown by way of example in the drawings and will herein be described in detail. It should be understood, however, that there is no intent to limit example embodiments of the invention to the particular forms disclosed, but on the contrary, example embodiments of the invention are to cover all modifications, equivalents, and alternatives falling within the scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Specific details are provided in the following description to provide a thorough understanding of example embodiments. However, it will be understood by one of ordinary skill in the art that example embodiments may be practiced without these specific details. For example, systems may be shown in block diagrams in order not to obscure the example embodiments in unnecessary detail. In other instances, well-known processes, structures and techniques may be shown without unnecessary detail in order to avoid obscuring example embodiments.

Also, it is noted that example embodiments may be described as a process depicted as a flowchart, a flow diagram, a data flow diagram, a structure diagram, or a block diagram. Although a flowchart may describe the operations as a sequential process, many of the operations may be performed in parallel, concurrently or simultaneously. In addition, the order of the operations may be re-arranged. A process may be terminated when its operations are completed, but may also have additional steps not included in the figure. A process may correspond to a method, a function, a procedure, a subroutine, a subprogram, etc. When a process corresponds to a function, its termination may correspond to a return of the function to the calling function or the main function.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “computer-readable medium” may include, but is not limited to, portable or fixed storage devices, optical storage devices, wireless channels and various other mediums capable of storing, containing or carrying instruction(s) and/or data.

Furthermore, example embodiments may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a storage medium. A processor(s) may perform the necessary tasks.

A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

As discussed herein, the term “image” refers to patterns or structures having one or more dimensions. For example, an image may refer to a 1 dimensional (1D) representation of an acquired pattern or structure, wherein the pattern is described as an array of values. The term image may also refer to a 2 dimensional (2D) representation of an acquired pattern, wherein the pattern is described as a matrix of values. Examples of such values may be intensity values, dimensional values (e.g., height or distances), magnetic property values, electrical property values, or other values describing physical properties. Image may also refer to an n-dimensional representation of an acquired pattern or structure. For example, an image may refer to a 3 dimensional (3D) representation of a cyclical 3D structure or a 2D representation of a plane of a 3D structure, e.g. including dimensional values.

As discussed herein, a pattern unit refers to a feature or group of features (portion of a pattern) repeating itself or themselves with a certain frequency. The pattern unit or unit pattern includes the contents of one period of a cyclical pattern or structure. Depending on image acquisition, the frequency may be a spatial frequency or a frequency in time.

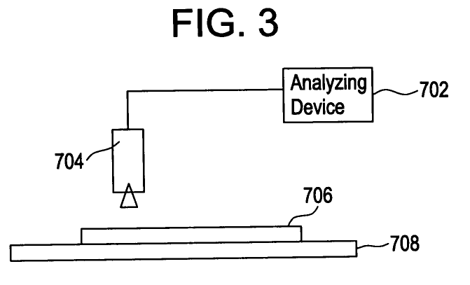

FIG. 3 illustrates, in a conceptual form, an image acquisition device for implementing methods according to example embodiments.

The imaging acquisition device shown in FIG. 3 may be, but is not limited to, for example an intensity measuring device such as a camera, an ellipsometer, a thickness meter, a contact probe, induction measuring device, etc. Methods according to example embodiments may be implemented in the image acquisition device or in any other conventional image acquisition device.

The image acquisition device in FIG. 3 may include an image acquisition unit 704 arranged above a workpiece holder 708. The workpiece holder 708 may hold a workpiece 706. An analyzing device 702 may be coupled to the image acquisition unit 704.

In at least one example embodiment, the image acquisition unit 704 may be a CCD camera. The CCD 704 may include a CCD array or matrix of pixels, which are a set of analog sensors arranged in an array matrix. Each sensor measures the amount of light hitting the active surface of the sensor. If the CCD array is placed in the image plane after some light collection optics (e.g., like in a camera) each sensor in the array measures a portion of the pattern or structure. All sensors together provide an approximation of the analog image in the image plane (e.g., where the sensors are placed).

Because the CCD array includes a limited number of sensors and each sensor output may be quantified to a limited number of discrete levels, an image acquired using a CCD array may suffer from resolution and/or gray level degradation.

The analog image captured by the CCD 704 may be output to the analyzing device 702. The analyzing device 702 processes the data output from the CCD 704. The analyzing device 702 may be a set of hardware and/or firmware for image acquisition. Image acquisition unit 704 may be a sensor such as a CCD array, TDI sensor or any other sensor for recording or acquiring an image. The analyzing device 702 may also include software for higher level analyzing functions. The analyzing device 702 may be implemented in the form of a computer or similar processing device. Because image acquisition units and analyzing devices are well-known in the art, a detailed discussion is omitted.

Example embodiments provide methods for detecting different errors in cyclical patterns. The errors that may be detected include, for example, offset, CD and/or shape errors. Instead of applying models for detecting edge placement in the image as in the conventional art, methods according to example embodiments use all or substantially all available edge information in the image simultaneously or concurrently. In a case in which a CCD or other light measurement device is used (e.g., as in FIG. 3), the difference in measured light intensity is used to detect and quantify errors, thereby avoiding the use of relatively complicated and error sensitive edge placement algorithms for determining geometrical placements of edges as in the conventional art.

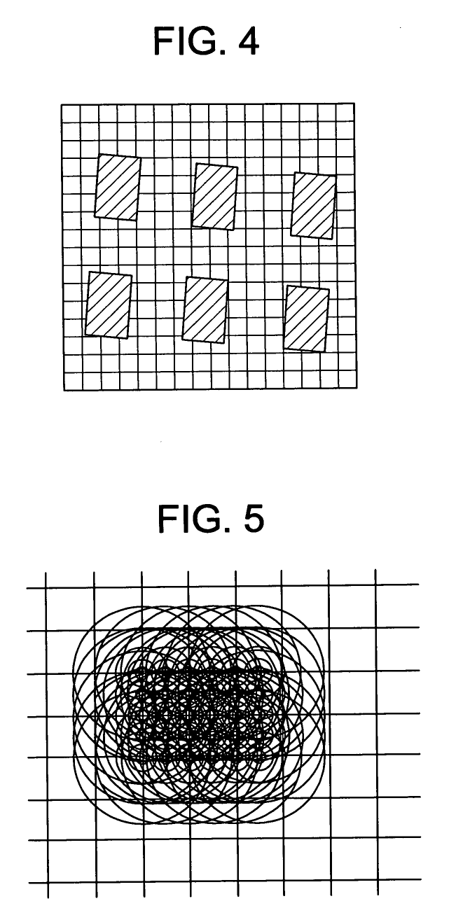

Normally, when an image of a pattern is acquired by a CCD, the pattern rotates. FIG. 4 illustrates a rotated portion of a cyclical pattern placed on a CCD grid. The plurality of rectangles shown in FIG. 4 represent a portion of a larger cyclical pattern. In this example, the pattern is rotated and not placed perfectly on the CCD grid. In other words, the pattern is rolling on the CCD grid.

When pattern rotation occurs, the edges in the image are not as sharp as in FIG. 4. The “sharpness” of an edge of an acquired image depends on the resolution (Point Spread Function (PSF)) of the optical system and the focus. When the PSF is relatively large or the optical system is not in focus during image acquisition, an edge containing placement information may be smeared out over several CCD pixels. When the edge containing placement information is smeared or spread out, several pixels along the edge include information of where the edge is relative the CCD grid. If the optical resolution or focus of the system is fixed and/or the number of pixels of the CCD array is raised, the number of pixels containing edge information increases.

If it is assumed that the optical system has an indefinitely high resolution, the pattern may resemble the portion of the pattern shown in FIG. 4. This is an ideal case. In this example, only one pixel along the edge on the CCD is affected by the transition of no-light to light. In this relatively unrealistic case, a relatively good estimation of the edge position in the CCD grid is achieved by examining the gray value of the pixel affected by the edge. A relatively simple formula for estimating the edge position within a CCD pixel is given by Equation (1) shown below.

EDGE_POSITION=(I(PIXEL)/MAX_INTENSITY)*CCD_GRID (1)

In Equation (1), I(PIXEL) is the measured intensity of a given pixel, MAX_INTENSITY is the maximum intensity in the entire image, and CCD_GRID is the grid of the CCD re-calculated to a nm scale. The grid CCD_GRID is set by the optical magnification of the image acquisition system and number of pixels in a certain direction in the CCD. In a conventional magnified image a 700 nm/pixel resolution may be used. The EDGE_POSITION in Equation (1) is the position of the edge relative the CCD grid re-calculated to the nm scale.

If, on the other hand, a more realistic transfer function of the optical system is assumed, information from several pixels along an edge in all directions is needed to estimate the edge position.

Realistically, the light in a point in the image plane is the sum of all the light surrounding that point. FIG. 5 shows a limited number of point sources emitting light defining a rectangular figure. If the shape of the pattern is compromised, the light hitting each pixel on the CCD array is the sum of light from several point sources (which, in reality, is an indefinite number). This sum (or number of photons) depends only on the distance from the source and the actual transfer function of the optical system (e.g., the Point Spread Function (PSF)).

### The Single Shift Method

### The 1D Case

At least one example embodiment provides a method for detecting errors in a 1D cyclical pattern in which an acquired image is shifted once and then compared to itself to detect errors in the image. The 1D cyclical pattern may be acquired using a scanning means of detection comprising a TDI sensor or a CCD camera, such as the registration measurement tool described in U.S. patent application Ser. Nos. 10/587,482, 11/623,174 and 11/919,219 assigned to Micronic Laser Systems AB. The entire contents of these patent applications are incorporated herein by reference.

When a scanning beam is used to record a cyclical pattern on a detector, a cyclical signal in the time domain is the expected result. This signal may be shifted (e.g., delayed) a certain time interval relative to itself in order to detect deviations from the expected cyclical behavior of the acquired pattern.

Mathematically, this time shift may be described by Equation (2) shown below.

I_DIFF(PIXEL)=I(PIXEL+PITCH)−I(PIXEL) (2)

Equation (2) represents the intensity difference between two pixels that are offset (PITCH) apart. In Equation (2), I(PIXEL) is the intensity of the image at a certain pixel or address of the grid. PITCH is the offset in number of pixels between two pixel units, or in other words, the offset between two identical parts of the pattern. Thus, I(PIXEL+PITCH) is the intensity at a pixel that is a number (PITCH number) of pixels away from the pixel PIXEL. Further, I_DIFF(PIXEL) is the Difference in intensity between pixels I(PIXEL+PITCH) and I(PIXEL).

More generally, Equation (2) can be re-written as Equation (3) shown below, where N is a positive or negative integer not equal to zero.

I_DIFF(PIXEL)=I(PIXEL+N*PITCH)−I(PIXEL) (3)

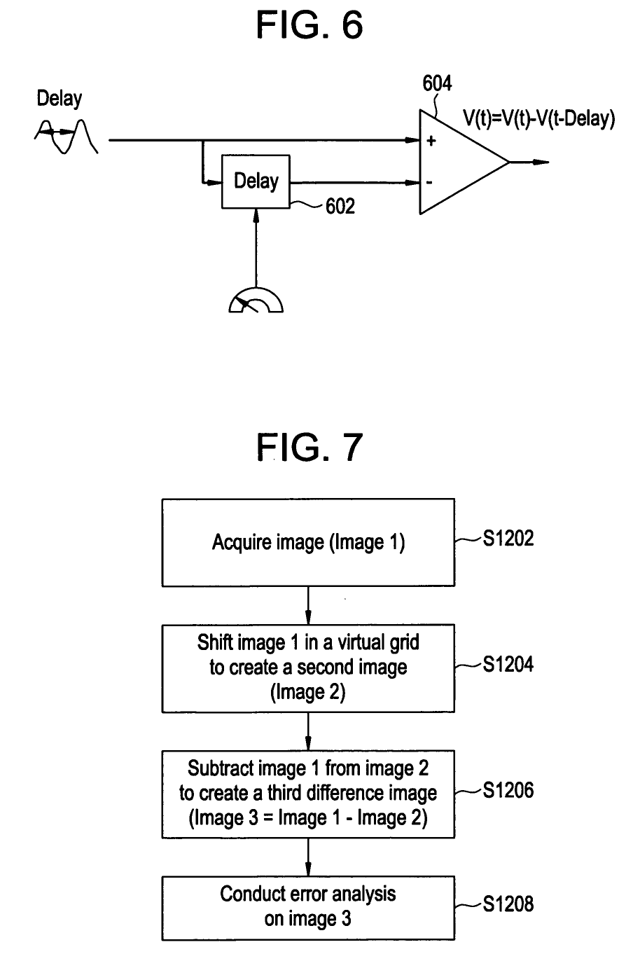

FIG. 6 illustrates an analog model of a demodulator implementing Equation (2). If the Delay 602 shown in FIG. 6 is adjusted to be one or more periods of the input signal, the carrier frequency may be suppressed and an output not equal zero may be seen if there is a difference between the input and the delayed input.

FIG. 6 illustrates the time domain effects of comparing a signal with itself in the 1D method. As shown, two different pixels in the virtual grid are compared in the space domain.

If no errors exist in the image, the result of the comparison between the pixels is zero. On the other hand, if there is a difference between the pixels, the error is detected as a positive or negative difference. In terms of a signal, the error corresponds to a positive or negative output signal from the comparator 604. It is important that the offset (PITCH) is greater than zero.

### The 2D Case

Another example embodiment provides a method for error detection in a 2D image. FIG. 7 is a flow chart illustrating a method for error detection according to an example embodiment. The method shown in FIG. 7 may be performed by the image acquisition device shown in FIG. 3, and will be described as such for the sake of clarity.

Referring to FIG. 7, at S1202 the image acquisition unit 704 acquires or records at least a portion of a cyclical pattern and sends the recorded image to the analyzing device 702. This image Image1 may be described as a two-dimensional pixel map, wherein all pixels are described by a value representing the acquired pattern properties for a given pixel position.

If the image acquisition unit 704 is a CCD (or any other image acquisition device), the recorded pattern property may be intensity and the two-dimensional pixel map may correspond to the CCD sensor matrix.

The pixel map may be located in a virtual grid extending beyond the pixel map. A portion of a virtual grid is shown in FIG. 10, which will be described in more detail below. In this virtual grid, subsequent images calculated from the acquired image may be located freely. According to example embodiments, the reference pixels are always on the grid because “PIXEL” in Equation (3) above, for example, is always an integer. The “PITCH” is a floating point number. Accordingly, example embodiments compare pixels on grid with pixels off grid.

Still referring to FIG. 7, at S1204 the analyzing device 702 shifts the recorded image Image1 a certain distance relative to itself in the virtual grid to generate a shifted image Image2. In other words, the recorded image Image1 is recalculated so that a new image Image2 is generated with the representation of the pattern properties (e.g., actual or interpolated pattern properties) found in different positions in the virtual grid.

In this operation, interpolation may be necessary if the distance of the shift is not a multiple of pixels in the recorded image Image1, but rather a real distance (or the projected distance) between two features in a cyclical pattern.

Still referring to FIG. 7, at S1206 the analyzing device 704 subtracts the acquired image Image1 from the shifted image Image2 to generate a difference image Image3. This difference image Image3 is a difference image including information about the differences between individual parts of the cyclical pattern. The generating of the shifted image Image2 may be calculated as an intermediate step or may be included in the calculation of the difference image Image3.

If the image acquisition unit 704 is a CCD, the mathematical interpretation of the generating of the first difference image Image3 may be described by Equation (4) shown below.

IDIFF(x,y)=I(x+i*X_PITCH,y+j*Y_PITCH)−I(x,y) (4)

In Equation (4), x is the pixel index in the X-direction, y is the pixel index in the Y-direction, X_PITCH is the pitch of the pattern in the X-direction on the CCD, Y_PITCH is the pitch of the pattern in the Y-direction on the CCD, ‘i’ is an integer defining number of X pitches, j is an integer defining number of Y pitches, I(x,y) is the intensity in pixel (x,y) of the acquired image (Image1), and IDIFF(x,y) is the intensity in pixel (x,y) of the difference image (Image3).

Still referring to FIG. 7, at S1208 the analyzing device 702 may perform an error analysis on the difference image Image3. As noted above, the analyzing device 702 may be a computer including error analyzing software to determine the difference from the black level in the difference image Image3. As mentioned above, the difference image Image3 is completely black if the acquired image Image1 and the shifted image Image2 are equal. Because the acquired image Image1 and the shifted image Image2 are actually the same image compared with itself, the difference in the difference image Image3 (positive or negative) reveals an error in the acquired image Image1. Because most of the acquired image Image1 does not contain any errors, most of the information in the difference image Image3 will be black pixels. Only pixels that not are black in difference image Image3 are analyzed. Accordingly, example embodiments provide a more efficient way to reduce the data that needs to be analyzed.

The analyzing device 702 may convert the differences in the difference image Image3 to an error in pixel scale using different methods. One method is to adjust the Y_PITCH and X_PITCH parameter in Equation (4) so that a minimum IDIFF is obtained. Because the real pitch of the pattern is known, the difference between the known pitch and the adjusted pitch is a measurement of the error in pixel scale. There are also other methods for transforming the error signal, that actually is in DAC units, to an error in the pixel domain. Using different mathematical models is another example of a manner in which this scaling may be performed.

In an ideal case in which no errors are present in the recorded image Image1 and the shift performed to generate the first shifted image Image2 is exactly one pattern pitch or a multiple of pattern pitches (e.g., one full period or multiple of periods of the cyclical pattern), the resulting difference image Image3 is “zero;” that is, all intensities are zero at portions in which the recorded image Image1 and the shifted image Image2 overlap.

The same result (theoretical base level of zero variation), may be achieved regardless of pattern properties, such as polarity, duty-cycle, etc. As a result, methods according to at least this example embodiment may be considered self-normalized. As discussed herein self normalized means that if an error is present, it will be of the same or substantially the same magnitude regardless of the properties of the cyclical pattern.

According to at least this example embodiment, if the virtual grid is a 2D grid in the X and Y dimensions, the above-mentioned shift may be performed in the X or Y direction, or in any angle or direction in between these two vectors. The length or distance of the shift may be about one period, or a multiple of periods of the spatial frequency of the pattern. The distance of the shift may also be chosen freely or arbitrarily.

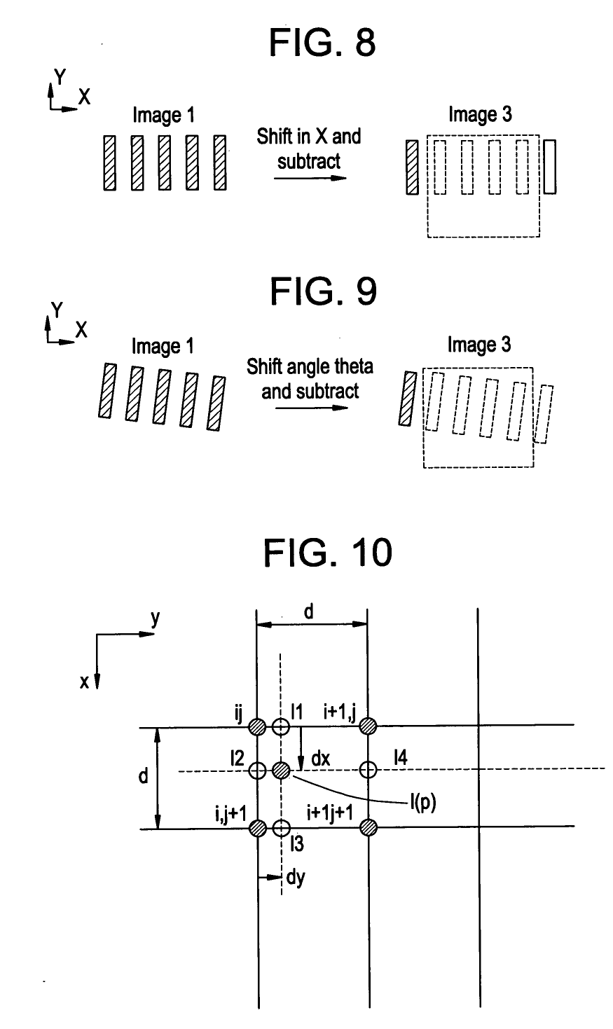

FIG. 8 illustrates an example acquired image Image1 and a difference image Image3. As shown, in this example the difference image Image3 is generated by shifting the recorded image Image1 in the X-direction of the virtual Cartesian grid and subtracting the shifted image Image2 from the recorded acquired image Image1.

FIG. 9 illustrates another example acquired image Image1 and a difference image Image3. As shown, the difference image Image3 may be generated by shifting the acquired image Image1 in an arbitrary direction (e.g., in an angled direction) of the virtual Cartesian grid and subtracting the shifted image Image2 from the acquired image Image1.

As shown by examining FIGS. 8 and 9, the resultant image in the Region of Interest (e.g., the area of the virtual grid overlapping from the acquired image Image1 and the shifted image Image2 denoted by the dotted outline) is cancelled out because the pattern has equal values in the points of the acquired image Image1 and the shifted image Image2 in these positions in the virtual grid.

In one example embodiment, the shift method may be described by the following pseudo code. In the pseudo-code, the “src” is a two dimensional matrix including the pixel values for the acquired image Image1. The “dst” is the result matrix including the pixel values for the difference image Image3.

For x=0 to xIndexMax
{

For y=0 to yIndexMax

{

dst(x,y)=get4PointValue(x+xPitch,y+yPitch)−src(x,y)

}

}

In this example, the CCD is the reference coordinate system. The acquired image (pattern) resides in a translated and rotated coordinate system relative the CCD grid matrix.

In practice the X_PITCH and Y_PITCH are rational numbers. It is rare that the pattern is “on grid” on the CCD. For this reason, interpolation may be performed in the CCD grid matrix when calculating the intensity of the pixels of the shifted image Image2 or alternatively when calculating the difference image Image3. Interpolation normally results in generation of an interpolation error.

A suitable interpolation algorithm may be needed to reduce this interpolation error. In one example, a four point interpolation algorithm or method may be used. For example, a 2D-4P interpolation may be used when calculating the shifted image Image2 or used directly in calculating the difference image Image3.

FIG. 10 illustrates a portion of a virtual grid for illustrating an example 4 point interpolation. The 4-point interpolation scheme is a relatively simple way to generate a virtual grid from a constant CCD grid. Of course, other ways to calculate a pixel intensity value based on surrounding pixels may be used.

In a four point interpolation, the intensity at point “p” may be calculated based on the intensities at the four virtual grid points surrounding the point p. The intensities at each of the four grid points may be calculated according to the following set of equations.

I1=I(i,j)+dy/d*(I(i+1,j)−I(i,j))

I2=I(i,j)+dx/d*(I(i,j+1)−I(i,j))

I3=I(i,j+1)+dy/d*(I(i+1,j+1)−I(i,j+1))

I4=I(i+1,1)+dx/d*(I(i+1,j+1)−I(i+1,j))

In the above sets of equations, I1-I4 are intensities at the vertices of the rectangle defined by the four grid points (i,j), (i+1,j), (i,j+1), and (i+1,j+1) in the CCD.

The intensity at point p may then be calculated according to the following set of equations.

I(p)=I1+dx/d*(I3−I1); or

I(p)=I2+dy/d*(I4−I2)

In a 2D case, rotation and scale errors must be handled when shifting acquired images. The inability to determine the real pitch, ideal pitch or average pitch of the pattern (i.e., the pitch with which to shift the acquired image) may also be a source of errors. Interpolation, rotation and scale errors that may occur when shifting and/or acquiring an image are discussed in more detail below.

Because it is impossible to capture an image without rotation between the CCD grid and the pattern, a difference in the 1D case due to the rotation is always present. It is important to realize that the error caused by rotation (and also scale) generates a constant non-black level in the shifted image. If the rotation is large, the “error” caused by the rotation effect may be much higher than the error being detected. But, after the second shift this constant error caused by rotation (or scale) is efficiently reduced because the constant is taken into account in determining the difference as shown in Equation (5) below. In Equation (5), constant refers to the constant error, I_DIFF(i) refers to the difference in intensity of pixel i between the acquired image and shifted image, and I_DIFF(j) refers to the difference in intensity of pixel j between the acquired image and shifted image.

(I_DIFF(i)+constant)−(I_DIFF(j)+constant)=I_DIFF(i)−I_DIFF(j) (5)

An interpolation error is, generally, present due to the limited number of sensors or pixels in, for example, the CCD. A constant rotation error in the difference image Image3 is introduced by rotating the pattern relative the CCD coordinate array or virtual grid if the shift is performed in a direction of one of the coordinate axis. The rotation error is in most cases constant. In this case, constant error means that a similar error is present in all or substantially all unit patterns in the difference image Image3; that is, all periods of the cyclical pattern of the difference image include a similar or substantially similar deviation caused by the rotation in the original image.

A global linear scale error (i.e., if a pitch of the acquired pattern increases or decreases in a linear fashion over the image) may also introduce a constant error in the difference image Image3. With respect to linear scale errors, constant error means that a similar or substantially similar error is present in all or substantially all unit patterns in the difference image Image3; that is, all or substantially all periods of the cyclical pattern of the difference image Image3 may include a similar or substantially similar deviation caused by the linear scale error present in the acquired image Image1.

If a suitable pitch of the pattern cannot be found, a constant error in the difference image Image3 may occur. With respect to pitch errors such as this, constant error means that a similar or substantially similar error is present in all or substantially all unit patterns in the difference image Image3, for example, all or substantially all periods of the cyclical pattern of the difference image Image3 include a similar or substantially similar deviation caused by the linear scale error present in the acquired image Image1.

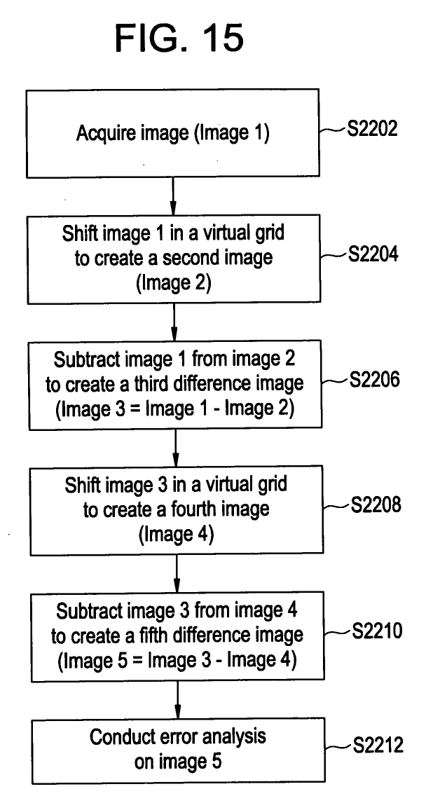

Due to above errors (e.g., rotation, scale, pitch, etc.), normally it may be impossible to achieve absolute zero intensity in each pixel in the difference image Image3 in the general case. However, the sources of rotation, scale and pitch estimation errors may be cancelled or at least reduced by including a second shift of the difference image Image3. This extended version of the single shift method is sometimes referred to herein as the double shift method. This example embodiment is described in more detail below with respect to FIG. 15.

### Interpolation Errors

As mentioned previously, the resolution of the image in the image plane relative the number of pixels, the sensor pitch and size of the CCD may affect how many pixels describe an edge of the pattern. The less the number of pixels/sensors affected by the edge, the larger the generated interpolation error.

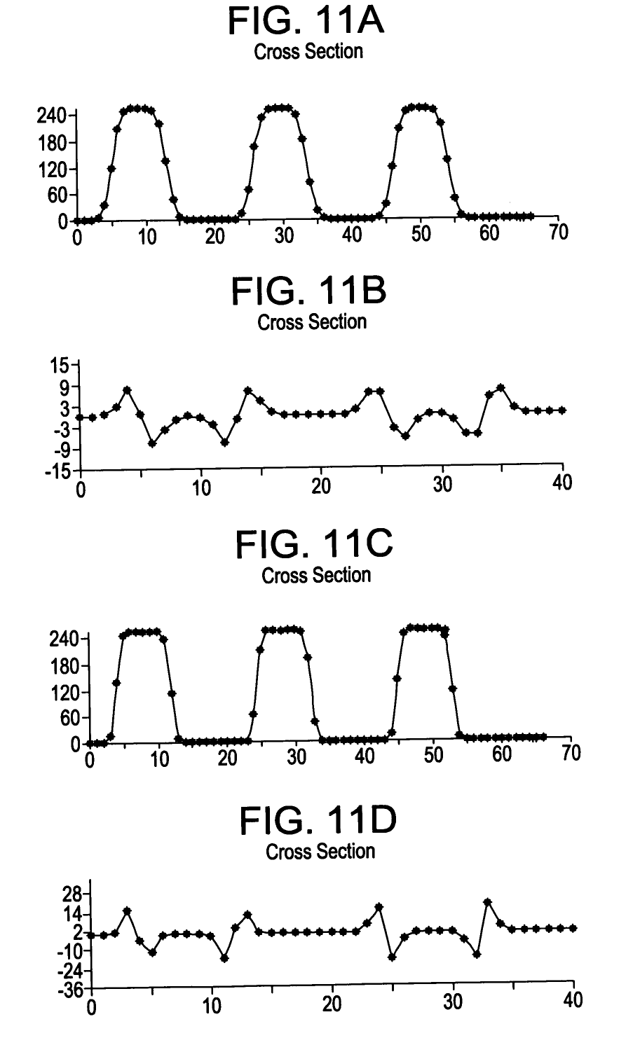

FIGS. 11A-11D are cross sections of a cyclical pattern of squares in the Y-direction. FIGS. 11A and 11C are cross sections of acquired images, whereas FIGS. 11B and 11D are cross sections of difference images generated as discussed above.

In this example, one square and half the distance between two squares on each side constitutes a unit pattern. This unit pattern is placed in a CCD grid of about 1 μm on the following positions 0.0, 20.5, and 41.0 μm. The size of the square in the Y-direction is about 8.0 μm and the pattern has been convolved by a Gaussian kernel with the half power width of about 5.0 μm.

FIGS. 11A-11D show a comparison of what happens with the interpolation error when sampling a signal with different derivatives of the edge and using a rough sampling grid. The sampling grid (actually the camera or CCD grid) is constant in the examples shown in FIGS. 11A-11D.

When the 1D shifted image is generated, an interpolation is performed. In this interpolation, the surrounding pixels must be used. In the transition region (e.g., where the interpolation error has its maximum or minimum), the signal has an inflection point. At the inflection point, the derivative changes sign. When interpolating, no assumptions of the actual shape of the signal are made. Accordingly, when the distance between the sampling points is relatively large compared to the edge derivative, the error is larger. This is because using data far from the inflection point does not represent the value in the reflection point (or close to it) very well.

Said another way, if the sampling grid is much smaller relative to the edge derivative, the interpolation error can be neglected because two points close to the point of interest represent the signal in this point better.

Referring to FIG. 11A, approximately 4 CCD pixels describe each edge in the pattern. In this example, the CCD used to obtain the pattern has a grid of about 1.0 μm. These points are represented by the dots in the graphs.

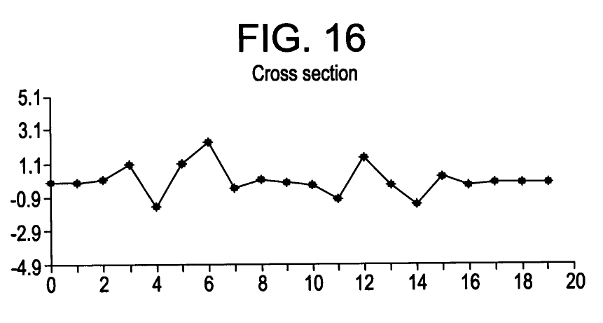

When comparing FIG. 11A with FIGS. 16B-16D, it can clearly be seen that the different unit patterns are described differently due to the position of the pattern edges in the fixed CCD grid.

If a difference image is generated based on the image shown in FIG. 11A as described above with regard to FIG. 7, the cross section plot shown in FIG. 11B is generated. In this example, the shifted image used in generating the difference image is shifted about 20.5 μm. In this example, the interpolation error of approximately +/−8 units exists.

If the optical resolution in the system (e.g., HPW=3 um) is enhanced, but the number of pixels in the CCD is maintained, an image having the cross section shown in FIG. 11C is acquired by the image acquisition device. The image in FIG. 11C is sharper than the image shown in FIG. 11A. Accordingly, a smaller number of pixels describe each edge. When the difference image is generated, interpolation error may increase.

FIG. 11D shows a cross section of a difference image generated based on the acquired image having the cross section shown in FIG. 11C. In this example, an interpolation error of approximately +/−14 units is present. The reason for the increase in the interpolation error between the difference image shown in FIG. 11B and the difference image in FIG. 11D is that the difference image in FIG. 11D has a less accurate approximation of the edge in the transition region.

Generally, interpolation errors in a shifted image increase as the degree of resolution increases.

### Rotation Errors

When executing a shift algorithm to generate the shifted image Image2 according to example embodiments, an interpolated pixel is subtracted from a reference pixel on the CCD. This operation is performed for each pixel in the image. FIG. 12 shows a portion of a pattern for explaining rotation errors.

If the image shown in FIG. 12 is shifted in the Y direction, for example, the difference in intensity may be calculated according to the following pseudo-code:

For x=0 to xIndexMax
{

For y=0 to yIndexMax

{

dst(x,y)=get4PointValue(x,y+yPitch)−src(x,y)

}

}

The above pseudocode describes a method for calculating a difference image according to an example embodiment. In the pseudocode, xIndexMax is the maximum index of the image in the X direction (int), yIndexMax is the maximum index of the image in Y direction (int), and Get4PointValue(x,y) is a function that calculates the interpolated value. The function Get4PointValue(x,y) operates on the src(x,y), which is the array of the raw data image. The pitch yPitch is an offset (in the Y direction) where the shifted data is captured in the image (float), dst(x,y) is an array to store the result generated by the pseudocode. In this example, the result is actually the 1D shifted image.

After performing the shift operation, only useful information remains in the gray shaded areas of the difference image. This is shown in FIG. 13.

As is evident, the rotation generates negative differences on top of the rectangle and positive differences below the rectangle in the difference image.

The rotation information is now transferred to an offset in the difference image. In this example, the rotation is exaggerated. Normally, the rotation of the image is relatively small so that the difference in offset between two rectangles is smaller than one pixel on the CCD. A similar effect is seen if a linear scale error exists in the image.

In the image shown in FIG. 13, another shift in the X direction may completely cancel effects of rotation errors in the acquired image. This will be further described in connection with the double shift example embodiment described in more detail below.

### Pitch Estimation Method

In accordance with example embodiments, parameters of the acquired image may need to be estimated. Parameters that may need to be estimated include, for example, the X and Y pitch of the acquired image. Even if the design pitch of a pattern on a plate or substrate is known (which in combination with the magnification of the system, the projected pattern pitches in the image plane is known), it can sometimes be of value to calculate the present pitches in an acquired image.

When the magnification is not known, the pitch may be calculated to determine how to perform adequate shifts to detect errors. Normally, pitches in different directions are used to define how much a shift should be performed in creating the difference image or determining subsequent shifts.

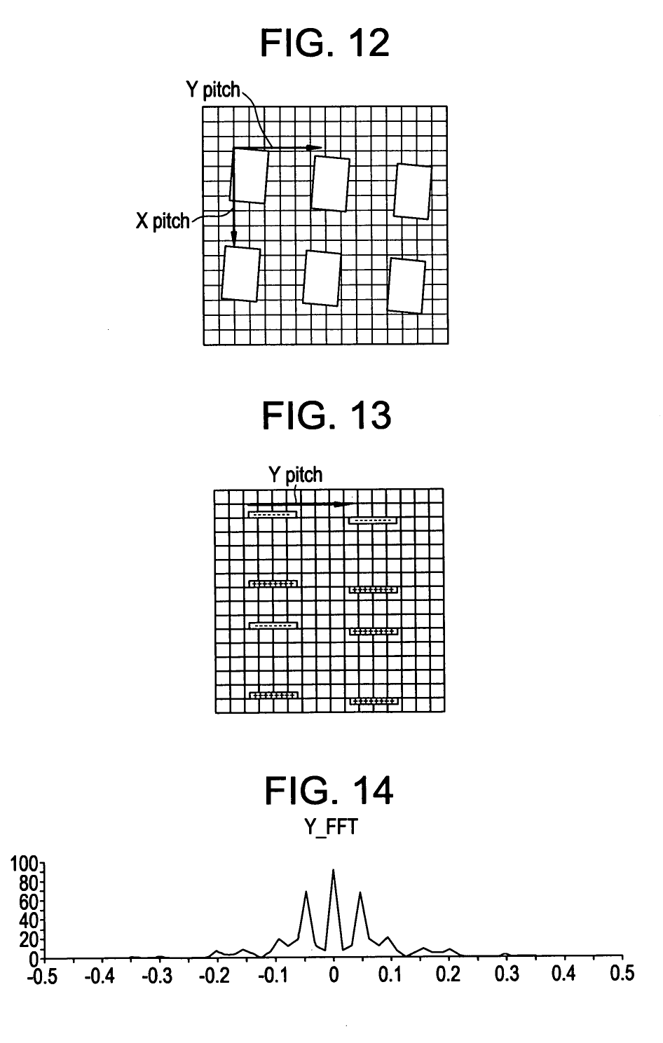

In one method of estimating pitches according to example embodiments, the first peak in the power spectra of the fast-fourier transform (FFT) of the pattern may be selected. This may be done using the cross section graph shown in FIG. 14.

In FIG. 14, it is worth noticing that an error in the estimated pitch later used for the shift in creating a difference image yields a constant or substantially constant error for all unit patterns. This type of error is similar or substantially similar in character to that of rotation and/or linear scale errors.

In a pattern with about 20 um pitch, a corresponding spatial frequency of about 0.05 is observed. In the FFT plot shown in FIG. 14, the first peak appears after the DC level. The DC level is the zero axis in the graph shown in FIG. 14. This point corresponds to a signal where the spatial frequency is 0. In one example, if an FFT of an image containing only constant data all “energy” is concentrated at this axis.

### Double Shift Methods for Detecting Errors According to Example Embodiments

FIG. 15 illustrates another method for error detection according to an example embodiment. The method shown in FIG. 15 is similar to the method of FIG. 7, but further includes a second shift. This shift further enhances the resultant difference image to more easily identify errors present in the image. As was the case with the method shown in FIG. 7, the method shown in FIG. 15 may be performed by the image acquisition device shown in FIG. 3. Because the first acquired image, the first shifted image and the first difference image may be the same as those described above with respect to FIG. 7, Image1, Image2 and Image3 will again be used in describing the method shown in FIG. 15.

Referring to FIG. 15, at S2202 the image acquisition unit 704 records at least a portion of a cyclical pattern and sends the recorded image Image1 to the analyzing device 702. The image acquisition unit 704 records the image Image1 in the same manner as described above with regard to S1202 in FIG. 7.

At S2204, the analyzing device 702 shifts the first recorded image Image1 a certain distance relative to itself in the virtual grid in the same manner as described above with regard to S1204 in FIG. 7.

At S2206, the analyzing device 702 subtracts the first image Image1 from the first shifted image Image2 to generate a first difference image Image3 in the same manner as described above with regard to S1206 in FIG. 7.

At step S2208, the analyzing device 702 shifts the first difference image Image3 in the same manner as the acquired image Image1 is shifted at S2202 to generate a second shifted image Image4.

At S2210, the first difference image Image3 is then subtracted from the second shifted image Image4 to generate a second difference image Image5. The second difference image Image5 may be generated in the same manner as the first difference image Image3 at S1206 in FIG. 7.

At S2212, the analysis device 702 may perform an error analysis on the second difference image Image5.

As described above, some remaining constant errors (e.g., effects from rotation, scaling, etc.) remain in the 1D image. In the 2D image these effects are reduced. As a result, only eventual “real” errors remain in the 2D image. Of course, second order scaling errors may still remain in the 2D image. But, these effects may be treated separately (and reduced) using statistics.

In the single shift method, effects from rotation, scale, pitch estimation errors, and/or interpolation remain in the difference image. This is a drawback when using a single shift because the real errors (the errors describing deviations between pattern units) may be relatively difficult to detect. Also, the effects of interpolation errors may degrade detection accuracy because the magnitude of those errors may be similar or substantially similar to the magnitude of the errors between the unit patterns.

These negative effects may be reduced or even eliminated if a similar shift and difference methodology is applied to the first difference image Image3.

In the same manner as the first shift, there is no limitation in direction of the shift. It can, however, be valuable from a calculation efficiency or throughput point of view to perform orthogonal shifts in the virtual grid. In the previous example discussing rotation errors, one can clearly see that a second shift in the X direction fully cancels out deviations created from rotation present in the first difference image Image1.

Moreover, if the first shift is performed a distance that is not equal or substantially equal to one period or an integer multiple of periods of the acquired image, errors result at a constant pitch in the first difference image Image3. The second shift may eliminate or at least reduce these errors in a second difference image Image5 if the first acquired image is shifted close to the constant pitch.

Other methods for the second shift may be used. Properties (e.g., shift distance or direction) of the second shift may depend on the type of error that is of interest to detect, or for example, the pattern design. The second shift distance may be chosen to be the same as that of the first shift, may be based on analysis of the first acquired image Image1 or the first difference image Image3, may be based on an FFT calculation of the first acquired image Image1 or first difference image Image3 or decided based on other parameters of interest.

The ability to eliminate or at least reduce these “first order errors” by using the double shift method is advantageous. For example, a system with relatively loose requirements on repeatability, lighting conditions, stability, optical performance, etc., may be built.

One further effect of the second shift is that interpolation errors may be reduced in the second difference image Image5.

If the same difference image described by the cross section in FIG. 11B is considered, after a first shift of 20.5 μm in Y direction the interpolation error of +/−8 units are observed, as previously described. After the difference image shown in FIG. 11B is shifted in the Y-direction, the cross section plot shown in FIG. 16 is obtained.

After the second shift, the amplitude of the interpolation error is reduced. In this example, an error of only about +/−1.5 units is present in the second shifted image. What is actually done in regard to interpolation in the second shift is essentially an interpolation in an already interpolated image.

This method of detecting relatively small deviations in at least a portion of a cyclical pattern may be implemented directly in the hardware of a conventional pattern error detection system such as the system shown in FIG. 3. For example, the method may be implemented via a computer (e.g., special purpose computer) connected to a conventional image acquisition device or within the analyzing device 702 shown in FIG. 3.

The method may of course also be performed on collected data (e.g., recorded images) after the collection of the images. Any combination between on-line shifting, off-line shifting and analyzing individual images or groups of images may be performed within the spirit of example embodiments.

### Classification of Errors

Methods according to example embodiments may also be used to defect mura defects as described in more detail below.

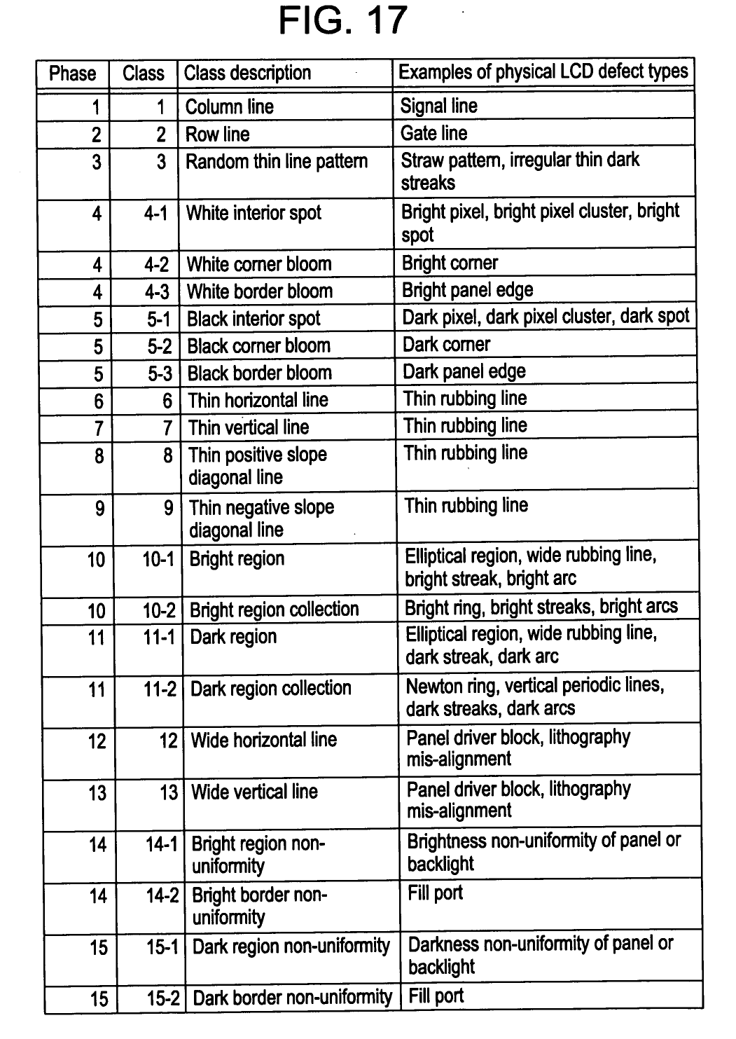

Mura defects can be classified in numerous ways. The Video Electronics Standards Association (VESA) has defined a Flat Panel Display Measurement Standard (FPDM) to classify errors in finished FPD modules. The classification is shown in FIG. 17. The VESA rules classify mura on finished panels driven to a certain gray level where defects appear as low contrast, non-uniform brightness regions, typically larger than single pixels. They are caused by a variety of physical factors. For example, in LCD displays, the causes of mura defects include non-uniformly distributed liquid crystal material and foreign particles within the liquid crystal.

Example embodiments detect mura before the modules are assembled. This means that mura may be detected at different stages in the manufacturing process. These stages may include detecting mura on a photomask, imprinting template, a substrate, and/or a wafer.

Further classification may be made by considering the layer by layer build up of a typical device.

Mura on a finished display or cyclical sensor may originate from defects present in one of the layers building up the device. These errors are referred to as intra-layer defects and are typically classified as CD, edge roughness, shape, and/or pitch errors.

Errors may also originate from relative displacement between layers, (e.g., inter-layer effects). Class alignment error, global and local distortions errors, scale errors, etc. may constitute the errors originating from relative displacement between layers.

On photomasks, for example, errors may be classified as CD, offset, or shape errors. CD errors are described as the difference in line width of a single or group of pattern units within a cyclical pattern. This class may have subclasses if a CD is larger or smaller than an intended value or the CD of surrounding features. Also an estimate of the absolute CD error may be included.

Offset errors are described as the difference in position of a single or group of pattern units within a cyclical pattern. Offset errors may have subclasses that define the direction of an offset in relation to the overall pattern. Also the number of affected pattern units may be included. Also an estimate of the absolute offset distance may be included.

Shape errors are described as the difference in shape of a single or a group of pattern units within a cyclical pattern. Shape errors may have subclasses defining different types of errors in shape. Also, the number of affected pattern units may be included. Also an estimate of the shape error in an absolute sense may be included.

Methods according to example embodiments may be used to detect and classify mura errors directly by analyzing an acquired image Image1 according to the disclosed shift and double shift methods. Also, the classification may be performed by combining the information obtained from multiple images subject to different shifting schemes.

For example, if an error extends outside the acquired image or constitutes an area larger than the acquired image, the error may be detected and classified using the information gained from a plurality of images, for example, classified individually by the single shift or double shift methods or a combination of both the single shift and double shift methods.

To visualize the error detection methodology according to example embodiments, an error is introduced in a general cyclical pattern. In this example, the introduced error is an offset error of one the pattern units relative to the surrounding pattern units or a CD error of one of the pattern units.

To simplify this explanation further only an error in the Y-direction is described in the following example. This is of course not to be considered a limitation of example embodiments, but rather as a way to facilitate an relatively easy and clear way of understanding example embodiments.

In this example, a pattern in the original image is represented as:
A B C D E F

In this example, A, B . . . , F represent intensities of pattern units in an acquired image (e.g., Image1 described above). Ideally, the pitch in the pattern is constant. Assuming this is an ideal case, the pattern units of a difference image generated based on the original image (e.g., B−A=C−B=D−C, etc.) are equal to K, where K is a constant.

This ideal case is not exactly the same as the actual case because a shift of one pattern unit generates a relatively small difference in pitch. To account for this difference, it is assumed that B−A=K+D(ab) and C−B=K+D(cb) and so on. The term D(*) accounts for all variations between the individual pattern units.

Rotation, scale and interpolation errors may also be introduced. (These errors may be seen as pattern unit intensity deviations when the pattern is shifted one or more pattern units). These errors may be described according to the following set of equations.

Rotation Errors→Rot(ab), Rot(bc) . . . Rot(fe)

Scale Errors→Scale(ab),Scale(bc) . . . Scale(fe) and

Interpolation Errors→IntErr(ab), IntErr(bc) . . . IntErr(fe).

Including these errors, D(*) may be determined according to the following equations.

D(ab)=Rot(ab)+Scale(ab)+IntErr(ab)

D(bd)=Rot(bc)+Scale(bc)+IntErr(bc)

D(fe)=Rot(fe)+Scale(fe)+IntErr(fe), etc.

Further, an error in one of the pattern units is also introduced. In a practical case, it is possible that all pattern units are shifted relative each other, but to simplify the description only errors affecting one particular pattern unit are considered in this example.

In one example, an error (e.g., an offset, CD, shape error) ‘e’ is introduced in pattern unit D of the original image. For ease of explanation, it is assumed that the introduced error e affects one edge of one pattern unit.

In this example, when performing a first shift in the Y-direction with a distance of the intended pattern pitch, the resulting differences (e.g., the difference image) may be described according to the following:

(B−A)(C−B)((D+e)−C)(E−(D+e))(F−E).

The D(*) introduced for each of the above differences is represented as follows.

D(ab)D(bc)D(dc)+eD(ed)−eD(fe)

By looking at this expression, it is easily realized that the effect of, for example, rotation errors is constant in the generated difference image.

Also, the effect of a linear scale error is constant in the generated difference image. Unlike the rotation and linear scale errors, interpolation error is not constant between the pixels in the difference image.

If D(*) is described as D(*)=R+S+Int, where R represents the constant rotation error, S represents the constant scale error and Int represents the interpolation error. By substituting D(*)=R+S+Int into the above D(*), the difference image may be described according to the following.

R+S+IntErr(ab)R+S+IntErr(bc)R+S+IntErr(dc)+eR+S+IntErr(ed)−eR+S+IntErr(fe)

In this example, error e may be much smaller than the rotation error R and the scale error S. Also the interpolation error term Int may be larger than the error e. This may pose some difficulties when detecting error e accurately. Because noise in the original image will be multiplied by the factor of two in the difference image, this also affects the ability to detect error e.

When the double shift method is applied, the second difference image may be described by the following.

(IntErr(bc)−IntErr(ab))(IntErr(dc)−IntErr(bc)+e)(IntErr(ed)−IntErr(dc)−2e)(IntErr(fe)−IntErr(ed)+e)

As can be seen, the effect of rotation and linear scale errors is suppressed and/or canceled.

In addition, the difference between two interpolation errors in each pixel is measured. In practice, this difference is relatively small for reasons described above, and is normally much smaller than the error e.

If this error is neglected, the representation of the error is seen more clearly. Namely, the error in a pattern unit may be described as follows.

0+e−2e+e

The above series shows the signature of an error of an edge in a pattern unit relative its neighbors. By looking for and identifying the above described signature, an error present in a first acquired image may be detected. Different combinations of errors, “e1”, “e2, “e3” etc., yield similar signatures. This makes it possible to determine the type of error present in the first acquired image. For example, a CD error may be distinguished from offset error based on analysis of the error signature in the second difference image, and thus, may be classified accordingly (differently).

Noise may set the lower limit in resolution regardless what method is used for measurement or detection. In example embodiments, all available information in the image is used simultaneously or concurrently in a relatively efficient way. This significantly reduces effects from noise. In the general case, a pattern unit is a set of features. These features have edges in different directions. All edges are used automatically when using methods according to example embodiments.

When a difference image is generated, all features within the original pattern unit contribute to the intensity in that pattern unit. Of course, the noise may be multiplied when we generate the difference image, but this is tolerable compared to the number of pixels used for the calculation. A simple example may be used to describe this.

If an edge in the pattern is assumed to include 100 pixels and N % of the 100 pixels are assumed to include at least some noise, the noise in each pixel of the difference image is multiplied by a factor of about two. But, because only the average light in a pattern unit is of interest, an average noise value of the pixel noise is calculated according as follows.

$$\frac{1}{\sqrt{100}} ( 2 N )$$

### Intensity to Dimension Conversion

Example embodiments provide methods for quantifying detected errors in patterns without the use of inaccurate human estimations or pre-determined calibration workpieces.

By being a self normalizing method (described above) in which the absence of errors yields a flat image with essentially the same value in all positions in the difference image regardless of the properties of the cyclical pattern being inspected, an error may be estimated (e.g., directly estimated) by analyzing the differences from the base values in the difference image.

Because methods according to example embodiments actually detect errors in a pattern by comparing different parts of the pattern to itself, information from the single shift image (first difference image) and/or double shift image (second difference image) may be used for estimating the geometrical size of detected errors.

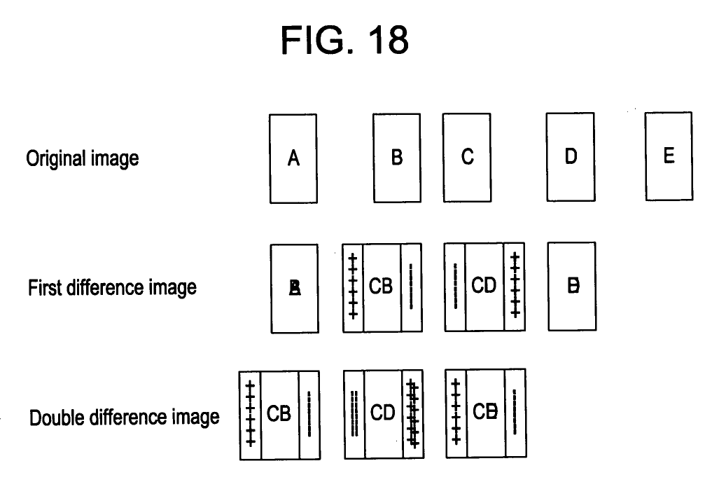

If, for example, considering an image acquired by a CCD in which the image is described by intensity values, the intensity information may be transferred to geometrical properties. This may be done in a variety of ways. One example method for determining a shift of a pattern unit relative to its neighbors is described below with regard to FIG. 18.

FIG. 18 is a geometrical presentation of what happens during a first and second shift of the method for detecting errors according to an example embodiment. In this example, an offset error has been introduced in the pattern unit C.

As shown in FIG. 18, after the first shift, a signature of the error (+e, −e) in the difference image pattern unit comparison (C−B) and (−e, +e) in the difference image pattern unit comparison (D−C). These are pattern units in the first shifted image.

In this example, the pattern is shifted one ideal pitch of the pattern. The pattern units that are equal do not generate any intensity difference in the first difference image.

In the first difference image, the comparison (A−B) and (E−D) is aligned so that no intensity is detected in these pattern unit positions (e.g., (A−B)=(E−D)=0).

This provides information of the error e in two pattern units in the first difference image ((C−B) and (D−C)).

False intensity in all pattern units in the first difference image may also be detected because the image is rotated, the first shift is not exactly a pattern pitch, and/or an un-predictable interpolation error exists.

A relatively simple method for estimating the size of the error e in μm is to minimize the intensity in one of the pattern units (C−B) or (D−C). This may be done using the relatively simple algorithm shown below.

Dy=.5
D=0

pattern_unit=“C−B”

Shift(yPitch+D)
minLight = measure(pattern_unit)
loop
{

D=D+Dy
Shift(yPitch+D)
light = measure(pattern_unit)
if (light<minLight) { minLight=light Dmin=D }
if (light>minLight) Dy=−Dy/2
if (abs(Dy)<0.001) break

}
Error_in_μm = D

In the above algorithm, Dy is a shift in μm and D is the sum of all Dy shift in the Y Direction.

The above-noted algorithm is only an example, and the method may be implemented by virtue of a variety of algorithms. Thus, example embodiments should not be limited by this particular implementation.

Using the first difference image for the measurement may have some drawbacks. For example, it is known that the pattern units in the first shifted image suffer from an unpredictable interpolation error. This error is typically the same magnitude as the error being detected using the methods described herein.

Accordingly, in another method of quantifying the magnitude of defects in a cyclical pattern, the effect of the shift in the double shifted image is calculated.

As shown in FIG. 18, in the first difference image the error may appear with different signs in two pattern units. In one example, this occurs for pattern units (C−B) and (D−C). For the pattern unit (D−C)−(C−B) in the double shifted image, two times the error is measured. Also, the interpolation error is relatively small in all pattern units in the double shifted image.

The following algorithm is an example implementation of the a shift of two pattern units only.

| Dy=.5 | |
|---|---|
| D=0 | |
| left_pattern_unit =”C−B” | |
| right_pattern_unit = “D−C” | |
| double_pattern_unit= “(D−C)−(C−B)” | |
| ShiftUnit(left_pattern_unit,yPitch+D) | ! This generates the |
| C−B pattern unit. | |
| ShiftUnit(right_pattern_unit,yPitch−D) | ! This generates the |

| D−C pattern unit. | |
|---|---|
| ShiftDouble(double_pattern_unit ,yPitch) | ! This |
| generates the (D−C)−(C−B) pattern unit. | |
| minLight= measure(double_pattern_unit) | |
| loop | |
| { | |

D=D+Dy
ShiftUnit(left_pattern_unit,yPitch+D)
ShiftUnit(right_pattern_unit,yPitch−D)
light = measure(double_pattern_unit)
if (light<minLight) { minLight=light Dmin=D }
if (light>minLight) Dy=−Dy/2
if (abs(Dy)<0.001) break

}

Error_in_μm = D

In a full implementation, the signature and magnitude for all pattern units in the double shifted image may be calculated. After this calculation in the double shifted image, the errors between individual pattern units in the first acquired image may be determined using logical operations.

### The Use of Several Images to Detect Mura Defects

At least one other example embodiment provides methods for detecting mura defects using information from several images. As has been described above, all errors within an image may be detected using single and double shifted image information. Of course, no information of what occurs outside of the captured image is available.

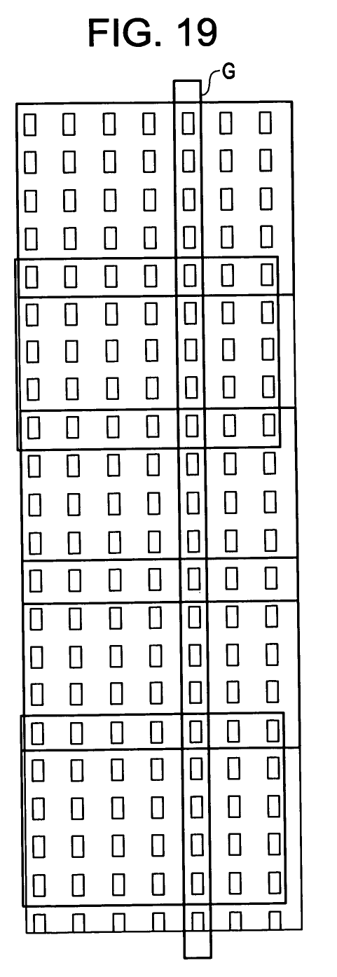

FIG. 19 shows an example of some overlapping images captured in the X-direction, for example, using the image acquisition unit shown in FIG. 3.

In this example, we do not need to know exactly where the images are taken in X or Y direction. Rather only approximately the same area (with some overlap) need be covered.

It is assumed that an error like one of the columns is shifted in the Y-direction (e.g., a butting error). In FIG. 19, the column is marked G. A random error shift error also exists among all columns with the same or substantially the same magnitude as the butting error. Assuming that it was possible to capture an image covering all 5 images in the X direction. The average difference between the columns may be calculated based on this image according to the following equation.

Ydiff(col)=ΣYdiff(Pixel_Unit(i)/number_of_pixelUnits.

In this equation, index “i” corresponds to the row index in column i. The average error for any column is zero for this large image without butting error. This means that Ydiff(col)=0 for a column without a butting error. This is because many pixel units are used in the calculation. The sigma in this average value may be expressed according to the following equation in which “n” is the number of pixel units in the calculation.

Sigma(Pixel_unit)/sqrt(n)

In FIG. 19, 5 images cover the area of interest. If one image is examined, the same average value may be calculated as described above. Accordingly, this calculation is based on only ⅕ of pixel units in the image. As a result, the Sigma for the average is worse. The average Sigma may be expressed by the following equation.

$$average\_Sigma ( Pixel\_unit ) = \frac{Sigma ( Pixel\_unit )}{\sqrt{\frac{n}{5}}}$$

In this example, there is assumed to be no overlap. The above equation may also be expressed as:

$$average\_Sigma ( Pixel\_unit ) = \frac{Sigma ( Pixel\_unit ) * \sqrt{5}}{\sqrt{n}}$$

This is a larger sigma as compared to the result based on the calculation on the large image. But, in the “merging” process we have information for all 5 images. Therefore, the average may be calculated in the same manner. The average for each image may be calculated separately and the average of the average for each image may be calculated. Alternatively, the calculation may be based on all Ydiff(i) together. In a case in which the entire pattern is shifted relative to a next image, this error may not be detected without some overlap between the images. The overlap provides information of the shift between images. Accordingly, overlap size may be considered important.

A simple example is used to explain this aspect of example embodiments.

If we assume that a random error within an image of 100 nm exists, and if the calculation is based on the differences yDiff(i) in the image, the sigma in the average is calculated according to the following equation:

$$\frac{1}{\sqrt{5}} * 100 nm .$$

If an overlap of “n” pixel units is used, a sigma for the pixel units in the overlap region of

$$\frac{1}{\sqrt{n * 2}}$$

is obtained. If the random error is known, the overlap needed for achieving certain accuracy may be determined.

The fact that the pattern moves around in the image only affects the interpolation error and where the photons for each pixel (e.g., a Thin-Film Transistor (TFT) pixel) are found in the difference image. Because the pitch of the pattern is significantly larger than the CCD pixel grid, it is more or less a trivial task to mask the TFT pixels belonging to the same pixel unit.

### Moiré Suppression

Because example embodiments rely on the comparison of one image to a shifted version of itself, the quality of the image is relatively important. Moiré is defined as unwanted artefacts in an image originating from, for example, beat frequencies between a pitch of a cyclical pattern and the recording of said cyclical pattern with a sensor having a cyclical behavior itself may lead to degradation of the image. One example is the recording of a cyclical display pattern using a CCD camera.

Under certain conditions, the acquired or recorded image shows intensity variations that do not originate from errors in the display pattern or the CCD itself, rather from differences between the imaged pattern pitch and the inherent pitch of the CCD chip.

Because methods of moiré reduction according to example embodiments are based on recording many images, the methods may not work for a method that relies on analyzing error based on a single recorded image.

In one example, the negative impact of moiré may be reduced by designing the image acquisition system such that severe moiré effects are avoided. In one example, a magnification in the system may be chosen so that the beating between the typical projected spatial pattern frequencies and the image acquiring unit does not result in severe moiré. A suitable resolution of the image acquisition unit may also need to be chosen.

An example will be used to illustrate a method for choosing magnification to minimize moiré. For the purposes of this example, a pattern with a known pitch of 100 μm is assumed.

A camera or CCD with a constant grid of 1000×1000 pixels is used to acquire the image. It is also assumed that zoom optics are used. The zoom may be adjusted so that the field size corresponds to N×Pitches of the pattern. In this case, N is an integer. If the zoom is adjusted so that 5 pixel units in the image field are acquired in Y-direction, 1000 pixels are being used to obtain these 5 units. In addition, each pixel unit uses exactly 200 pixels in the Y-direction in the camera. Accordingly, the pattern will be on grid in the camera in the Y-direction. Because the pattern is on the grid, moiré effects are reduced and/or eliminated. Naturally the pattern will also be on grid in the other direction (e.g., the X-direction) if it is assumed that the same grid has been used in the data in both directions.

In another example embodiment, the image may be recorded using a detection system in which the beat frequencies (e.g., which are the source of moiré artefacts) between the inspected pattern and detection system are suppressed by matching the pitches of the projected pattern on the image sensor in at least one direction with the inherent pitches of the image sensor. The inspection system may use zoom optics for adjusting the magnification so it “fits” the pattern. In other words, the recorded pattern is placed on the grid of the camera or CCD.

In this example embodiment, the relation between the pitch of the pattern to be recorded and the inherent pitch of the sensor may be changed. The sensor may be, for example, a CCD. To clarify, the relation between the period of the projected pattern on the sensor and the period of the sensor itself may be controlled in a suitable manner to match the pitches as necessary.

To suppress and/or eliminate moiré artefacts, the projected pattern pitch and the sensor pitch must match exactly. This exact match may be impossible as long as the relationship between the pitches is chosen in such a way that the resulting beat frequencies do not affect the recorded image severely. For example, if the spatial frequency of the resulting moiré pattern is long enough, deterioration of the recorded image by the resulting moiré pattern may be suppressed.

The changing of the relation between the pitches may be done in a number of ways for example by changing the magnification of the optical system projecting a pattern image on an image acquiring device, for example, using an optical zoom. This may be done in one or two dimensions with, if necessary, two different magnifications. Another method of changing the relation between the pitches is to change the angle of the incoming detection field on the detector array or matrix of, for example, the CCD.

In another example embodiment, the relation between the pitches may be changed by tilting and/or rotating the workpiece or the imaging acquisition system relative to one another.

The moiré suppression methods may be performed on a part of the cyclical pattern before performing inspection/detection of the full pattern, for example, before performing a pattern dependent calibration of the image acquisition system. In another example embodiment, methods of mura suppression may be performed during inspection of the pattern. In this example, the setting of, for example, the optical system may be changed during inspection.

Means of finding the correct setting may be used to acquire an image of the pattern to be inspected, identify a moiré pattern by pattern knowledge or measurement of the pattern pitch and knowledge of the imaging system and imaging acquirement unit, thereby further changing the ratio between the imaged pattern pitch and image sensor pitch.

Example embodiments also provide super sampling methods.

As mentioned above, in many places a camera (e.g., a CCD, TDI sensor or any other image acquisition device) with a limited number of pixels in the X and Y directions is used. By using a relatively high magnification in the optical system, each edge in the acquired image may be described by many pixels. In this case, enough information regarding the real shape of the edge is obtained. Using relatively high magnification is not what is preferable, however, because the image field shrinks as the magnification increases. Relatively small image fields means that many images may be needed to cover the pattern. Many images and relatively high magnifications may result in a relatively expensive system.

Conventionally, if lower magnification and limited number of pixels in the camera system are used, the edge may not be sampled with enough points to determine the shape of its transfer function. This leads to a large interpolation error.

Methods according to example embodiments reduce the necessary magnification while still obtaining enough points to determine the shape of the edge. Example embodiments provide methods for reducing the necessary magnification in order to acquire as large an area as possible in each image and as many pixel units as possible.

Methods described above may be used in the same manner, but using the super sampled data. The only difference is that a much higher resolution is obtained when sampling the pattern.

A super sampling method according to an example embodiment will be described with regard to FIG. 12, which shows a portion of a pattern.

If it is assumed, for the purposes of this example, that the pattern is not rotated relative the camera grid, each point of the pattern is perfectly aligned with the camera grid. If an edge in the pattern is traced in the X direction, for example, each pixel in this direction samples the same physical point of the transfer function. In this example, the transfer function is in the Y-direction. This is trivial because the pattern is exactly aligned with the pixel grid of the camera. The only difference of the sampling points in this direction is that they are different due to effects from noise.

In addition, not information regarding the transition function is obtained until the next pixel in the Y-direction. The distance to next pixel in Y-direction is relatively large due to the limited number of pixels in the camera. When interpolating as described above with respect to FIG. 10, for example), a relatively large interpolation error is generated. The information between the sampling points cannot be reconstructed. In the middle of the transfer function (e.g., close to the inflection point) the error is at a maximum.

If the pattern is rotated relative the camera grid, the situation is completely different.

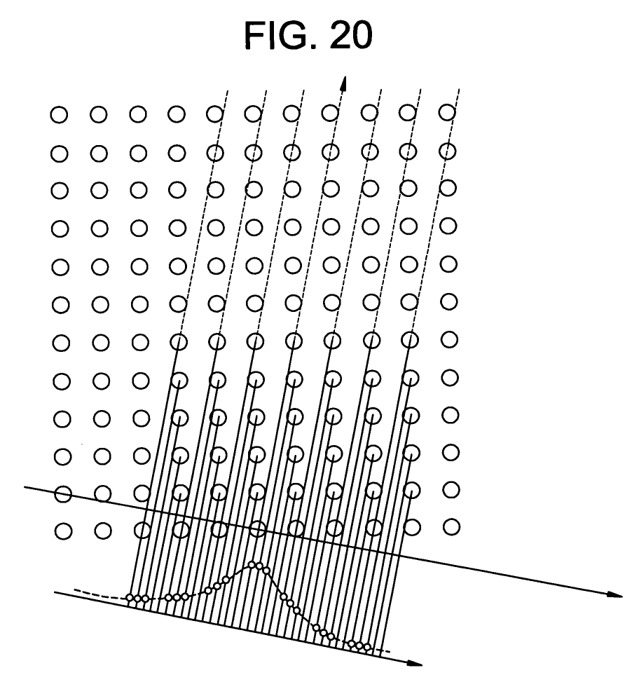

Referring to FIG. 12, each pixel in the camera samples the edge at different physical points of the transfer function when following the edge. Accordingly, more information regarding the edge transition function is obtained when following the edge. This is shown in FIG. 20.

In this example embodiment, the pattern is extended at least some in the “edge” direction. If the edge is known to be straight (not curved), all sampled pixels may be treated together along the edge as a description of the transition function.

If the pattern is rotated, for example, 5 pixels over 100 pixels in the other direction, a 20 times higher resolution is obtained when the edge transfer function is estimated. If the relatively simple interpolation described above is used, a much smaller interpolation error is obtained.

If the rotation of the pattern is known, that actually is quite trivial to calculate from the image itself, the redundancy along any edge in the pattern is known. Longer edges provide more redundancy and higher accuracy when estimating the transfer function.

Because noise is always present in an image, some pixels are needed for averaging. Pixels that are spread out along the gradient direction of the edge are better for averaging than pixels that are not spread out. In this example, the gradient direction is the direction 90 degrees rotated from (perpendicular to) the edge direction.

Using super sampling methods, the amount of data needed for analyzing does not expand, and a much larger image field (lower magnification) compared to the pattern pitch is used. As a result, fewer images are needed to cover the pattern and still be able to use relatively high resolution along the edges where the necessary information is located.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

1. A method for detecting defects on a workpiece including an at least partly cyclical pattern, the method comprising:
acquiring at least a first image of at least a portion of the cyclical pattern;
generating a second image by shifting the first image relative to its original position in a virtual grid;
creating a third image by performing a mathematical or logic operation on the first image and the second image to create the difference image; and
analyzing the third image to detect defects present in the first image.

2. The method of claim 1, wherein the detected defects in several first images are used to detect mura defects.

3. The method of claim 2, wherein the several first images are overlapping.

4. The method of claim 1, wherein the virtual grid used to detect the defects is rotated relative the cyclical pattern in order to obtain a higher resolution when estimating an edge transfer function.

5. The method of claim 1, wherein the detected defects are classified as different errors.

6. The method of claim 1, wherein the detected defects are classified as mura.

7. The method of claim 1, wherein the analyzing includes,
measuring an intensity variation in the third image, and wherein the method further includes,
pitch matching a projected pattern pitch and an imaging sensor pitch to reduce the measured intensity variation

8. The method of claim 7, wherein the pitch matching includes,
changing a projected image size on an image sensor in at least one direction.

9. The method of claim 7, wherein the pitch matching includes,
changing a projected image size uniformly on an image sensor.

10. The method of claim 7, wherein the pitch matching includes,
changing a projected image size on an image sensor by a first factor K in a first direction and a second, different factor L in a second direction.

11. The method of claim 7, wherein the pitch matching includes,
changing a projected image size on an image sensor by tilting the workpiece relative to the imaging plane of the image sensor.

12. A method for detecting defects on a workpiece including an at least partly cyclical pattern, the method comprising:
acquire at least a first image of at least a portion of the cyclical pattern;
generating a second image by shifting the first image relative to its original position in a virtual grid;
creating a third image by performing a mathematical or logic operation on the first image and the second image to create the difference image;
shifting the third image relative to its position in the virtual grid to generate a fourth image;
performing a mathematical or logical operation on the fourth image to generate a fifth image; and
analyzing the fifth image to detect defects present in the first image.

13. The method of claim 12, wherein the detected defects in several first images are used to detect mura defects.

14. The method of claim 13, wherein the several first images are overlapping.

15. The method of claim 12, wherein the virtual grid used to detect the defects is rotated relative the cyclical pattern in order to obtain a higher resolution when estimating an edge transfer function.

16. The method of claim 12, wherein the detected defects are classified as different errors.

17. The method of claim 12, wherein the detected defects are classified as mura.

18. The method of claim 12, wherein the analyzing includes,
measuring an intensity variation in the third image, and wherein the method further includes,
pitch matching a projected pattern pitch and an imaging sensor pitch to reduce the measured intensity variation

19. The method of claim 18, wherein the pitch matching includes,
changing a projected image size on an image sensor in at least one direction.

20. The method of claim 18, wherein the pitch matching includes,
changing a projected image size uniformly on an image sensor.

21. The method of claim 18, wherein the pitch matching includes,
changing a projected image size on an image sensor by a first factor K in a first direction and a second, different factor L in a second direction.

22. The method of claim 18, wherein the pitch matching includes,
changing a projected image size on an image sensor by tilting the workpiece relative to the imaging plane of the image sensor.

23. An apparatus for detecting defects on a workpiece including an at least partly cyclical pattern, the apparatus comprising:
means for acquiring at least a first image of at least a portion of the cyclical pattern;
means for generating a second image by shifting the first image relative to its original position in a virtual grid;
means for creating a third image by performing a mathematical or logic operation on the first image and the second image to create the difference image; and
means for analyzing the third image to detect defects present in the first image.

24. The apparatus of claim 23, wherein said means for acquiring is a CCD camera.

25. The apparatus of claim 23, wherein said means for acquiring a TDI sensor.

26. The apparatus of claim 23, wherein the at least partly cyclical pattern is a 1-dimensional pattern.

27. The apparatus of claim 23, wherein said at least partly cyclical pattern is a 2-dimensional pattern.

28. The apparatus of claim 23, wherein said at least partly cyclical pattern is a 3-dimensional pattern.

29. The apparatus of claim 23, wherein said at least partly cyclical pattern is a 2-dimensional representation of a 3D structure.

30. An apparatus for detecting defects on a workpiece including an at least partly cyclical pattern, the apparatus comprising:
means for acquiring at least a first image of at least a portion of the cyclical pattern;
means for generating a second image by shifting the first image relative to its original position in a virtual grid;
means for creating a third image by performing a mathematical or logic operation on the first image and the second image to create the difference image;
means for shifting the third image relative to its position in the virtual grid to generate a fourth image;
means for performing a mathematical or logical operation on the fourth image to generate a fifth image; and
means for analyzing the fifth image to detect defects present in the first image.

31. The apparatus of claim 30, wherein the means for acquiring is a CCD camera.

32. The apparatus of claim 30, wherein the at least partly cyclical pattern is a 1-dimensional pattern.

33. The apparatus of claim 30, wherein said at least partly cyclical pattern is a 2-dimensional pattern.

34. The apparatus of claim 30, wherein said at least partly cyclical pattern is a 3-dimensional pattern.

35. The apparatus of claim 30, wherein said at least partly cyclical pattern is a 2-dimensional representation of a 3D structure.

36. A method for detecting defects on a workpiece at least partly including a cyclical structure or being at least partially covered with an at least partly cyclical pattern, the method comprising:
acquiring at least a first image, the first image including at least one part of said cyclical pattern;
mapping the first image onto a virtual grid;
shifting said first image in said virtual grid to generate a second image, the first image being shifted relative to an original position of the first image;
generating a third image based on the first and second images; and
detecting defects on the workpiece based on the third image.

37. The method of claim 36, wherein the generating further includes,
subtracting the first image from the second image to generate the third image.

38. The method of claim 36, wherein the detected defects are one of CD, OFFSET and SHAPE errors.

39. The method according to claim 36, wherein the first image is acquired with a detection device oriented at a direction perpendicular or substantially perpendicular to the workpiece.

40. The method according to claim 36, wherein the first image is acquired with a detection device oriented at an oblique angle from the workpiece.

41. The method according to claim 36, wherein said second image is rotated before shifting.

42. The method according to claim 36, wherein said second image is mirrored before shifting.

43. The method according to claim 36, wherein the analyzing of the third image is done in real time.

44. The method according to claim 36, wherein the detecting step is performed between recordings of subsequent first images.

45. The method according to claim 36, wherein the ratio between the shift distance of the second image and at least one pattern pitch present in at least one direction in the cyclical pattern to be inspected is an integer or a ratio of integers.

46. A method for detecting defects on a workpiece at least partly including a cyclical structure or at least partly covered with an at least partly cyclical pattern, the method comprising:
acquiring at least a first image, the first image including at least one part of said cyclical pattern;
mapping the first image onto a virtual grid;
shifting said first image in said virtual grid to generate a second image, the first image being shifted relative to an original position of the first image in the virtual grid;
generating a third image based on the first and second images;
shifting said third image in said virtual grid to generate a fourth image, the third image being shifted relative to an original position of the third image in the virtual grid;
generating a fifth image based on the third and fourth images; and
detecting defects on the workpiece based on the fifth image.

47. The method of claim 46, wherein the detected defects are one of CD, offset and shape errors.

48. A method for suppressing moiré effects in an image acquisition device, the method comprising:
controlling beat frequencies between an inspected pattern and a detection system by changing a ratio between a pitch of the projected pattern on an image sensor and inherent pitches of the image sensor in at least one direction.

49. A method for controlling influence of moiré in an acquired image, the method comprising:
acquiring an image of the pattern to be analyzed;
measuring energy content for at least a portion of frequencies deemed as constituting critical moiré;
changing a ratio between the pitch of a projected pattern on the image acquisition unit and inherent pitches of the image acquisition unit in at least one direction;
re-measure the energy content for at least a portion of the frequencies deemed as constituting critical moiré; and
iterating the changing and re-measuring until a desired energy content is achieved for the critical frequencies.

50. A method for detecting at least one of deviations and defects on a workpiece at least partly covered with a cyclical pattern, the method comprising:
recording at least a first image of at least one part of said cyclical pattern, the recording being performed using a digitized image recording unit;
calculating a second image within the first image by performing interpolation based on the first image and an estimation of the pitch of the pattern, wherein the interpolation is four point interpolation, and the pitch is a floating point number;
subtracting the first image from the second to generate a first difference image, the subtracting including subtracting all pixels of the first image from all corresponding pixels in the second image in a cyclical manner;
calculating a second difference image by performing interpolation based on the first difference image and an estimation of the pitch of the pattern, wherein the interpolation is four point interpolation, and the pitch is a floating point number; and
analysing the second difference image to locate deviations present in first recorded image.

51. The method of claim 50, further including,
subtracting the first difference image from the second difference image to generate a third difference image, the subtracting including subtracting all pixels of the first difference image from all corresponding pixels in the second difference image in a cyclical manner; wherein
the two shifts in the first image remove effects from different error sources in the first image, the error sources including rotation errors, errors in the pattern pitch estimation, intensity distribution errors, and interpolation errors.

52. The method of claim 50, wherein generation of the first and second difference images are performed in different directions to pinpoint different types of errors in the first image.

53. The method according to claim 50, wherein the second difference image is further enhanced by performing additional shifts and mathematical or logical operations.

54. The method according to claim 50, wherein the error vector based on the result from the first difference image or the second difference image is generated and used to pinpoint the errors in the first image.

55. The method according to claim 50, wherein said first image or first difference image is rotated before shifting.

56. The method according to claim 50, wherein said first image or first difference image is mirrored before shifting.

57. The method according to claim 50, wherein the ratio between the shift distance (pitch) of the first difference image and the second difference image is at least one pattern pitch present in at least one direction in the cyclical pattern to be inspected is an integer or a floating point number.

58. The method according to claim 50, wherein a plurality of images are used (separately analyzed) to generate global statistics error vectors for pinpointing long wave errors in the pattern.

59. A method for detecting defects on a workpiece at least partly covered with a cyclical pattern, the method comprising:
recording at least a first image of at least one part of said cyclical pattern;
inverting said recorded first image to create a second image;
shifting, in a virtual grid, said second image different distances in at least one direction;
performing mathematical or logical operations on said first image and said shifted second image for each distance creating numerous sub images;
combining the sub-images to create a fourth image having a size larger than said first image; and
analyzing the fourth image to find deviations present in full first recorded image.

60. The method according to claim 59, wherein the ratio between the shift distance of the second image, or secondary images, and at least one pattern pitch present in at least one direction in the cyclical pattern is an integer or a ratio of integers.

61. A method for determining the optimal setting for a certain pattern, the method comprising:
recording at least a first image of at least one part of a known cyclical pattern;
inverting said recorded first image to create a second image;
shifting, in a virtual grid, said second image in at least one direction; and
performing mathematical or logical operations on said first image and said shifted second image creating a third image.

62. The apparatus of claim 30, wherein the means for acquiring is a TDI sensor.
